(19) United States
(12) Patent Application Publication
(10) Pub. No.: US 2018/0132006 A1
(43) Pub. Date: May 10, 2018

(54) HIGHLIGHT-BASED MOVIE NAVIGATION, EDITING AND SHARING

(71) Applicants: Yaron Galant, Palo Alto, CA (US); Federico de Samaniego Steta, Xalapa (MX); Martin Boliek, San Francisco, CA (US)

(72) Inventors: Yaron Galant, Palo Alto, CA (US); Federico de Samaniego Steta, Xalapa (MX); Martin Boliek, San Francisco, CA (US)

(21) Appl. No.: 15/340,779

(22) Filed: Nov. 1, 2016

Related U.S. Application Data
(60) Provisional application No. 62/249,826, filed on Nov. 2, 2015.

(51) Int. Cl. H04N 21/472; G06F 3/01; H04N 21/854

(52) U.S. Cl. CPC H04N 21/47205; H04N 21/854; G06F 3/017; H04N 21/47217

(57) ABSTRACT

Methods and apparatuses for highlight-based movie navigation, editing and sharing are described. In one embodiment, the method for processing media comprises: playing back a movie on a display of a media device performing gesture recognition to recognize one or more gestures made with respect to the display; and navigating through the media on a per highlight basis in response to recognizing the one or more gestures.

### PRIORITY

The present patent application claims priority to and incorporates by reference corresponding U.S. provisional patent application Ser. No. 62/249,826, titled, “IMPROVED HIGHLIGHT-BASED MOVIE NAVIGATION, EDITING AND SHARING,” filed on Nov. 2, 2015.

### FIELD OF THE INVENTION

The technical field relates to capturing, storing, processing editing and viewing of video data. More particularly, the technical field relates to generating videos of potentially interesting events in recordings.

### BACKGROUND OF THE INVENTION

Portable cameras (e.g., action cameras, smart devices, smart phones, tablets) and wearable technology (e.g. wearable video cameras, biometric sensors, GPS devices) have revolutionized recording of data associated with activities. For example, portable cameras have made it possible for cyclists to capture first-person perspectives of cycle rides. Portable cameras have also been used to capture unique aviation perspectives, record races, and record routine automotive driving. Portable cameras used by athletes, musicians, and spectators often capture first-person viewpoints of sporting events and concerts. Portable cameras lend themselves, through long battery life and ample storage space, to spectator recording events. For example parents record their children playing youth sports, celebrating birthdays, or being active at home; spectators of a race or a game recording the event, and people recording their friends in social activities. As the convenience and capability of portable cameras improve, increasingly unique and intimate perspectives are being captured.

Similarly, wearable technology has enabled the proliferation of telemetry recorders. Fitness tracking, GPS, biometric information, and the like enable the incorporation of technology to acquire data on aspects of a person's daily life (e.g., quantified self).

In many situations, however, the length of recordings (i.e., time and/or data, also referred to in the film era as “footage” or “rough footages”) generated by portable cameras and/or sensors may be overwhelming. People who record an activity often find it difficult to edit long recordings or to find or highlight interesting or significant events. Moreover, people who are subjected to viewing such recordings find them to be tedious very quickly. For instance, a recording of a bike ride may involve depictions of long uneventful stretches of the road. The depictions may appear boring or repetitive and may not include the drama or action that characterizes more interesting parts of the ride. Similarly, a recording of a plane flight, a car ride, or a sporting event (such as a baseball game) may depict scenes that are boring or repetitive. Manually searching through long recordings for interesting events may require an editor to scan all of the footage for the few interesting events that are worthy of being shown to others or storing in an edited recording. A person faced with searching and editing footage of an activity may find the task difficult or tedious and may choose not to undertake the task at all. Some solutions for compressing the data, and in particular the time are being developed and offered from fast forwarding, selective compression, or hyperlapse technologies. However, in all of the above, the editing is linear in nature and does not offer an automatic means of generating the distilled video clip of an event based on external meta data and/or preferences. Moreover, the prior art process of generating a distilled video is fixed, not taking into account the viewer's preferences and or the system requirements allowing for multiple resulting outputs dynamically generated form a single source of recorded data.

### SUMMARY OF THE INVENTION

Methods and apparatuses for highlight-based movie navigation, editing and sharing are described. In one embodiment, the method for processing media comprises: playing back media on a display of a media device performing gesture recognition to recognize one or more gestures made with respect to the display; and navigating through the media on a per highlight basis in response to recognizing the one or more gestures.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1A illustrates different elements that comprise a video creation process from the capture of raw video data to creation of a final-cut version.

FIG. 1B illustrates that multiple instantiations of both a rough-cut and a final-cut that may be generated based on multiple instantiations of a MHL and tagging systems.

FIG. 2 is a flow diagram of one embodiment of a process and various operators for creating a summary movie.

FIG. 3A is a flow diagram of another embodiment of a process for creating a summary movie.

FIG. 3B illustrates a session interpreter accessing previous highlight list data of an individual user to create movie compilations.

FIG. 4A-C illustrate an example of a thumb (or finger) tagging language.

FIG. 5 depicts a block diagram of a system server.

FIG. 6 is a block diagram of a portion of the system that implements a user interface (UI).

FIG. 7A is a flow diagram of one embodiment of a process for tagging a real-time stream.

FIG. 7B is another embodiment of the real-time capture implementation of the system.

FIG. 8 illustrates one embodiment of an instrumented movie player.

FIG. 9 shows the difference between a timeline and a highlight line for navigating the movie playback.

FIGS. 10A and 10B show a visual page containing highlights that can be included.

FIGS. 11A and 11B illustrate a visual page containing both highlights that are included in the movie and highlights that can be included.

FIG. 12 illustrates one embodiment of a user interface with a mosaic presentation of highlights with checkboxes.

FIG. 13 illustrates an example of trimming of a single highlight.

FIG. 14 is a block diagram of one embodiment of a smart phone device.

FIG. 15 shows a number of computing and memory devices.

FIG. 16 shows a single device with multiple functions.

FIG. 17 shows one embodiment where the signals are captured by a smart phone device, the media data is captured by a media capture device, and the processing is performed by cloud computing.

### DETAILED DESCRIPTION OF THE PRESENT INVENTION

### Overview

A video capture, highlighting, editing, storage, sharing and viewing system is described. The system records or otherwise captures and/or receives from one or more other capture devices raw video and generates or receives metadata or signal information associated with the video and or certain portions thereof. The system then, via adaptable editing, generates one or several versions of videos (e.g., movies), which may include one or several variant versions of the rough-cut of the raw video data and one or several versions variants of the final-cut. The process of determining the rough-cut and or the final-cut is based on the metadata generated.

There are three roles (“stakeholders”) in the process: (a) the originator(s) such as the videographer, director, photographer or source integrator, who captures the video(s); (b) the intermediary, also referred to as the editors(s) who creates the rough or final cut(s); and (c) the viewer(s), also referred to the consumer, who consumes or views the final cut. Specifically, the system's flexibility allows different individuals or automated systems or predefined role of the editor(s).

In one embodiment, the rough-cut is an intermediate state in which some or most of the data that was gathered and stored in the raw stage is discarded. The rough-cut can refer to extracted rough-cut media clips, a rough-cut highlight list, and/or a rough-cut version of a summary movie. In one embodiment, the final-cut is defined as an edited version of the rough-cut, ready for viewing by the consumers. The final-cut can refer to extracted final-cut media clips, a final-cut highlight list, and/or a final-cut version of a summary movie.

A variety of rough-cut or final-cut video versions may be generated based on different interpretation of the signal data by different stakeholders, systems or people. That is, the system allows different editors to create and ultimately view different, personalized versions of a movie. Therefore, when a video recording is made, the different versions ultimately generated from the video recording are not limited to a fixed result, but a dynamically malleable “movie” that can be modified based on the interpretation of the meta data using the preferences of different users.

As will be described below in more details, some embodiments of the system have one or more key characteristics including, but not limited to:
a. temporal tokenization of an experience, by allowing editing of “moments” captured in video, which is in tune with the typical human experience;
b. malleability which enables the originator, the intermediary, and/or viewer to create, edit, and consume the video content differently;
c. automatic gathering and encoding of signal data information;
d. manual insertion of signal information;
e. automation of operations like editing, storage, upload, sharing, and compilations;
f. learning (e.g., machine learning) capabilities to empower the automation;
g. interactive user models that allow individual users to affect the outcome of different stages of the data processing while reducing friction and distraction;
h. mashup capabilities allowing automatic or manual incorporation of videos snippets captured by different devices and people;
i. search, browse, and other discovery tools that facilitate locating specific moments;
j. compilation creation that blend highlights from past activities into summary movies (e.g., best-of, same activity year over year);
k. commercialization system that calculates monetary values according to various rules relating to the use of the system; and
l. commercialization system that defines the usage or subscription of the originators, editors and viewers.

### Overview of the System

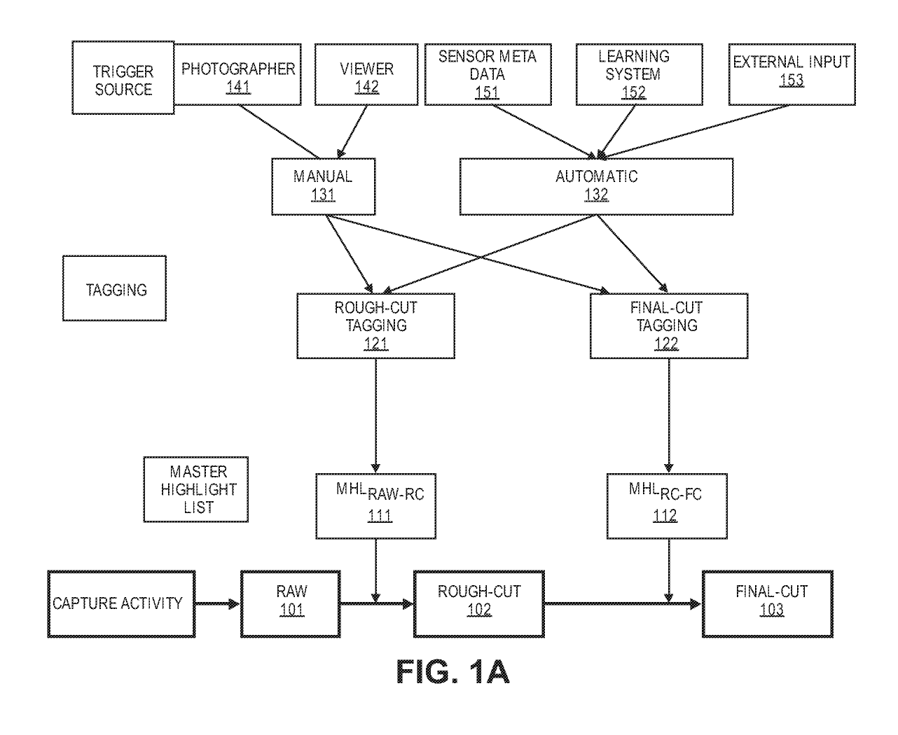

FIG. 1A illustrates different elements that comprise the video creation process from the capture of raw video data to creation of a final-cut version. Referring to FIG. 1A, there are three elements: video (101,102,103), tagging (121, 122) and editing instructions known as Master Highlight Lists (111,112). Specifically, a system captures data to create raw video 101. Such capture can be continuous (meaning a continuous video recording) or can be manually controlled (either by pausing or concatenation of a selection of video segments) or triggered by external sensors (such as motion sensors, location sensors etc.). A rough-cut version of the data is generated and stored as rough-cut 102 and a final-cut is generated and potentially stored or viewed as final-cut 103.

The transformation instructions between the different stages are referred to as Master Highlight Lists (also referred to as “MHL”). The transformation instructions between raw (101) and rough-cut (102) are referred to as MHL_{Raw-RC} (111). The transformation between rough-cut (102) and final-cut (103) are referred to as MHL_{RC-FC} (112). The metadata (or otherwise referred to as signal data) is stored as tags. The tagging of the raw images which are used to generate the rough-cut are depicted in 112 and the tagging that is generated to create the Master Highlight List that generates the final-cut from the rough-cut are depicted in 122.

### Video

In one embodiment, the video capture device is a video camera. In yet another embodiment, the video capture device is a smart phone. In still another embodiment, the video capture device is an action camera. In yet another embodiment, the video capture device is a wearable device. In principal, that any device having a camera capable of capturing an activity on video may be used.

The capturing, meaning storage of the raw video into a temporary buffer, and the recording, meaning the storing of the data into persistent memory, are two different activities. In one embodiment, the capture of an activity is performed continuously, and only portions of the raw video are recorded. In one embodiment, the capture device does not need to use an on/off button. Instead, the video capture occurs as soon as an application is started on the capture device. Alternatively, the capturing starts as soon as the user performs a gesture with the capture device (e.g., moving the device in a particular manner). In yet another embodiment, the capture device begins recording according to a specific command (e.g., pressing a button). In yet another embodiment, the capture device begins and stops recording according to a specific command (e.g., pressing a button). In yet another embodiment, the capture device may pause according to a specific command (e.g., pressing a button) and resume according to a specific command. In such cases, the raw data may continuously store the various segments as a single instantiation of the raw data clip.

In some devices, the settings for the capture of video (e.g. resolution, frame rate, bitrate) are different for the captured frames, the preview screen that is presented to the user in real-time, and the encoding and storage of the raw video. In some embodiments, the frame image is capture at a high resolution and quality (bitrate) and is then saved as a still image at high resolution and quality and also as a video frame at a lower resolution and bitrate.

In one embodiment, raw video 101 is stored permanently to enable access the new video data in the future. In yet another embodiment, only the rough cut is being permanently stored. One may consider the stored raw video as an extreme version of the rough-cut that was not trimmed. The storage may be part of the capture device or at another device and/or location. In one embodiment, such a location can be a remote server, also referred to as cloud storage.

Raw video 101 is edited by an editing system to create rough-cut video 102. In one embodiment, rough-cut video 102 is generated from raw video 101 on the fly. In one embodiment, raw video 101 is temporarily stored and is discarded after editing into rough-cut video 102. The editing system may be part of the capture device or may be a device coupled to the capture device or remote from the capture device (e.g., a remote server or cloud storage).

Subsequently, rough-cut video 102 is further edited to create final-cut video 103. In one embodiment, final-cut video 103 is generated on the fly. Note that in one embodiment, final-cut video 103 is generated from raw video 101.

Each version of the video (e.g., the raw video, rough-cut video, and final-cut video) may be associated and or generated by the same or different party (e.g., a photographer, a viewer, a system).

### Tagging

MHL 111 of rough-cut video 102 and MHL 112 of final-cut video 103 are generated in response to tagging. For example, MHL 111 is generated in response to rough-cut tagging 121. Similarly, MHL 112 is generated in response to final-cut tagging 122. Tagging is an indication provided to the capture system (or other system performing video and editing) indicating that a segment of video should be retained or otherwise marked for inclusion into another version of the video.

Tagging may be performed manually (131) or automatically (132) and occurs in response to a trigger source. In the case of manual tagging 131, the trigger source is an individual. In one embodiment, the individual is the photographer of the activity (i.e., the capture device operator or originator). In another embodiment, the individual providing the manual trigger is a viewer of raw video 101 and/or rough-cut video 102. In another embodiment, the individual is a human editor (i.e. intermediary). The individual viewing raw video 101 may view it after viewing rough-cut video 102 and/or final-cut video 103 in order to gain access to the original raw video.

In the case of automated tagging, the trigger source is an input from a plugged device. With respect to automatic tagging 132, the trigger sources may include one or more of sensor metadata whether in the devices 151 or external to the device 153 or have a sensor or machine learning system 152. In one embodiment, machine learning systems 152 aggregates individual experiences from one or more client devices and uses algorithms that act upon that information to predict triggers. The individual experiences may be associated with the same or similar activities or from the same or other individuals. Sensor devices 151 and 153 may include either exact data points, relative data points or change in data points. Exact data may include GPS data, sound, temperature, heart rate, and/or respiratory rate. Relative data may include one or many as linear acceleration, angular accelerating, a change in the exact data triggered either by a relative, or as an absolute threshold values (e.g. G-Force, change in heart rate, change in respiratory rate, etc.). Other sensor types include accelerometer, gyro, magnetometer, biometric (e.g., heart rate, skin conductivity, blood oxidization, pupil dilation, wearable ECG sensor), other telemetry (e.g., RPM, temperature, wind direction, pressure, depth, distance, light sensor, movement sensor, radiation level, etc.).

Note that automatic tagging and manual tagging can occur in conjunction with each other, can augment each other (increasing the score and/or altering start and end times), or can override each other. In such a case, the interpreter (described below) determines and/or selects which tags control the rough-cut and/or final cut creation.

### Master Highlight List (“MHL”)

The master highlight list or a collection of lists is a list of one or more segments (or highlights) of the captured activity. In some embodiments, the individual highlights in the master highlight list include the start time, the end time and/or duration, and one or more score(s). The scores are assigned by the analyzer process and/or the interpreter process (see description below). These scores can be used in many different ways, described below. In some embodiments, the description of the highlight also indicates pointers to media data that is relevant to that highlight (e.g., video, annotation, audio that occurs at the time of the highlight). There can be many sources of media for one highlight.

In one embodiment, rough-cut video 102 and final-cut video 103, including any and all different versions of the two, are generated based on a single master highlight list (“MHL”). The MHL is generated from the tags based on the signal data. The signal data (meta data) are either generated automatically or manually. In one embodiment, these segments are the segments having content of interest, at least potentially, to the originator (e.g., a photographer, a director, etc.), the intermediary, or another viewer. More specifically, rough-cut video 102 is created from raw video 101 based on a master highlight list 111. Similarly, final-cut video 103 is a subset of the rough-cut, generated from rough-cut video 102 in response to master highlight list 112. In some embodiments, the final-cut master highlight list (sometimes called a movie highlight list) is a processed subset of the rough-cut master highlight list. Movie and Master highlight lists 111 and 112 can have several instantiations such that there are numerous different versions of rough-cut video 102 and many different versions of final-cut video 103. These different instantiations may be different because a different party is generating different tags. For example, when the master highlight list is generated by the photographer (or capture device operator) the highlight list may be different than when it's generated by a system or a viewer of the video (e.g., a viewer of raw video 101, a viewer of rough-cut video 102). The highlight list may be different still from the highlights generated by an editor (a person or a computer program accessing the captured data after the capture has taken place and before the viewing).

Thus, when editing the captured raw video 101 into rough-cut video 102 and final-cut video 103 to include their respective lists of highlights, the editing is controlled via tagging which may be controlled by the capture device operator (e.g., photographer), a system, or a separate individual viewer.

FIG. 1B illustrates that multiple instantiations of both the rough-cut (102) and the final-cut (103) may be generated based on multiple instantiations of the MHL (111,112) and the tagging systems (121,122) respectively. More specifically, according to one embodiment, and as depicted in FIG. 1B, video 101 may be edited in a number of different ways to create a number of different rough-cut versions of raw video 101. Similarly, the rough-cut video 102 may be edited in a number of different ways, thereby creating a number of different final-cut versions of raw video 101 (and a number of different versions of rough-cut video 102).

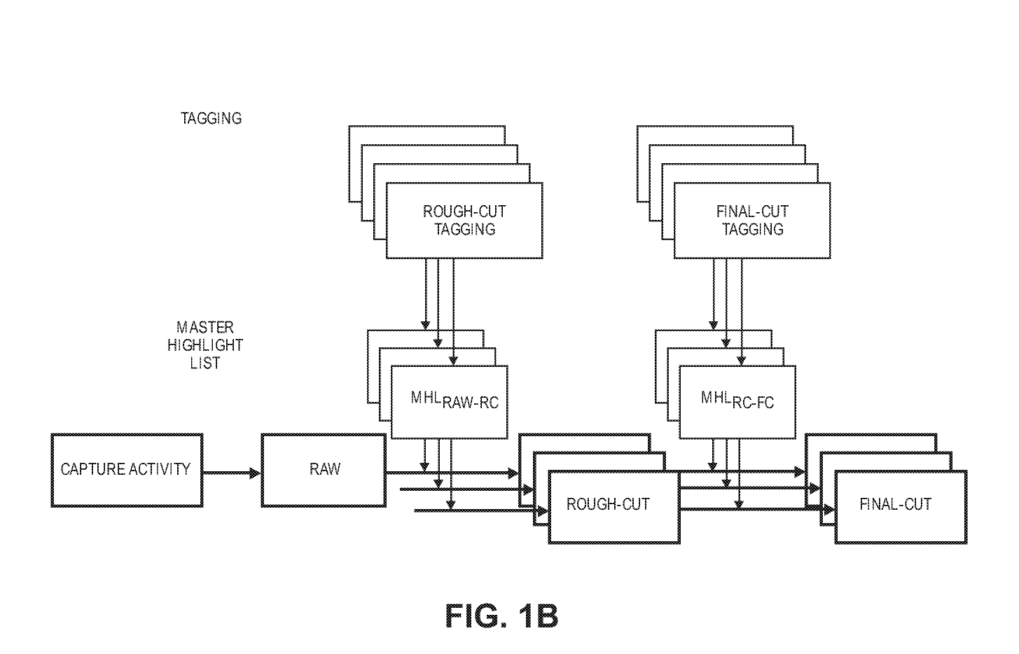

FIG. 2 is a flow diagram of one embodiment of a process and the various operators for creating a summary movie. The summary movie may comprise one of the rough-cut versions or one of the final-cut versions described above with respect to FIGS. 1A and 1B. The process is performed by processing logic that may comprise hardware (circuitry, dedicated logic, etc.), software (such as is run on a general purpose computer system or a dedicated machine), firmware, or a combination of the three. Furthermore, in some embodiments, all of the processes in FIG. 2 are performed on the same machine (e.g., a local client smart phone, a Personal Computer (PC), remote cloud computing, etc.). In other embodiments, the processes and the data can be distributed between two or more machines.

Referring to FIG. 2, the process obtains signal data 210. Signal data 210 is the raw data, and may include, for example, audio stream(s), video(s), sensor(s) data, or global positioning system (GPS) data, manual user input, etc. In one embodiment, any data that is separately captured is signal data 210. In one embodiment, signal data 210 comprises media data.

In one embodiment, signal data 210 includes all the physical, manual, and implied source of data. This data can be captured before, during and/or after some real-time activity and is used to aid in the determination of highlights in time.

In one embodiment, media data 250 includes all of the resources (raw, rough-cut and/or final-cut clips and/or summary movies) used to compile a presentation or summary video. Media data 250 can include video, audio, images, text (e.g., documents, texts, emails), maps, graphics, biometrics, annotation, etc. While video and movies are discussed most frequently with reference to the term media data 250 herein, the techniques disclosed herein are not limited to those two forms of media.

The difference between signal data 210 and media data 250 is how they are used in the processing described herein. In some embodiments, some data is used for both signal data 210 and media data 250. For example, in some embodiments, the audio track is used both as a signal for determining tags and as media for creating rough-cut and final-cut movies.

### Sensors

Sensor data may include any relevant data that can correspond with the captured video. Example of such sensors include, but are not limited to: chronographic (e.g. clock, stopwatch, chronograph, etc.); acoustic sound; vibration; geophone; hydrophone; microphone; motion; speed (e.g., odometer) used measure the instantaneous speed of a land vehicle; speed sensor used to detect the speed of an object; throttle position sensor used to monitor the position of the throttle in an internal combustion or an electric engine; fuel mixture sensor such as AFR or O2 sensor; tire-pressure monitoring sensor used to monitor the air pressure inside the tires; torque sensor or torque transducer or torque meter used to measure torque (twisting force) on a rotating system; vehicle speed sensor (VSS) used to measure the speed of the vehicle; water sensor or water-in-fuel sensor, used to indicate the presence of water in fuel; wheel speed sensor, used for reading the speed of a vehicle's wheel rotation; navigation instruments e.g. GPS, direction; true airspeed; ground speed; G-force; altimeter; attitude indicator; rate of climb; true and apparent wind direction; echosounder; depth gauge; fluxgate compass; gyroscope; inertial navigation system; inertial reference unit; magnetic compass; MHD sensor; ring laser gyroscope; Tturn coordinator; TiaLinx sensor; variometer; vibrating structure gyroscope; yaw rate sensor; position, angle, displacement, distance, speed, acceleration; auxanometer; capacitive displacement sensor; capacitive sensing; free fall sensor; gravimeter; gyroscopic sensor; impact sensor; inclinometer; integrated circuit piezoelectric sensor; laser rangefinder; laser surface velocimeter; LIDAR; linear encoder; linear variable differential transformer (LVDT); liquid capacitive inclinometers; odometer; photoelectric sensor; piezoelectric accelerometer; position sensor; rate sensor; rotary encoder; rotary variable differential transformer; Selsyn; shock detector; shock data logger; tilt sensor; tachometer; ultrasonic thickness gauge; variable reluctance sensor; velocity receiver; force, density, level; Bhangmeter; hydrometer; force gauge and force sensor; level sensor; load cell; magnetic level gauge; nuclear density gauge; Geiger counter; piezoelectric sensor; strain gauge; torque sensor; viscometer; proximity, presence meters; alarm sensor; Doppler radar; motion detector; occupancy sensor; proximity sensor; passive infrared sensor; Reed switch; stud finder; heart monitor; blood oxidization sensor; respiratory rate monitor; brain activity sensor; blood glucose sensor; skin conductance sensor; eye tracker; pupil dilation monitor; triangulation sensor; touch switch; wired glove; radar; sonar; and video sensor; and any and all collections of sensor data used to determine the motion, impact, and failure in vehicles (e.g. sensors that deploy airbags in cars, sensors associated with “black boxes” in aircraft).

### Analyzer

Analyzer 215 receives signal data 210 and creates tag data 220. In essence, the analyzer 215 process defines points in time with respect to signal data 210. For example, analyzer 215 may tag a point in a video capture, thereby creating tag data 220 that specifies a portion of the video that has a predetermined length (which can be provided per activity or adjusted by the user as a, e.g., 6 seconds for a basketball game or 30 seconds for a soccer game etc.). In one embodiment, analyzer 215 tags multiple portions of signal data 210 so that tag data 220 specifies multiple pieces of signal data 210. In one embodiment, analyzer 215 incorporates machine vision, statistical analysis, artificial intelligence and machine learning. In some embodiments, the analyzer 215 creates one or more scores for each tag.

### Interpreter

Interpreter 225 receives tagged data 220 and creates highlight list data 240. In one embodiment, each of the highlights in highlight list data 240 includes a beginning of the highlight, an ending of the highlight, and a score. Interpreter 225 generates the score for each highlight.

In one embodiment, interpreter 225 generates highlight list data 240 in response to inputs that control its operation. In one embodiment, those inputs include previous highlight list data 230, which include data corresponding to a previously generated list of highlights. Such sets of previous highlights are useful when going from a raw cut to multiple final-cuts or from a rough-cut to multiple final-cuts. In this manner, highlight list data 240 provides a context to the system when making rough-cuts or final-cuts. For example, see Galant et al., U.S. Patent Application Publication No. 2014/0334796, filed Feb. 25, 2014.

### Extractor

After highlight list data 240 has been created, extractor 245 uses highlight list data 240 to extract media clips from signal data 210 to create media clip data 260. In one embodiment, extractor 245 performs the extraction based on media data 250. Media data 250 can be raw video, rough-cut video, or both.

### Composer

Composer 265 receives media clip data 260 and creates summary movie data 280 therefrom in response to composition rules data 270. Media clip data 210 can be rough-cut clips, final-cut clips, or both. Composition rules data 270 includes one or more rules for compositing summary movie data 280 from media clip data 260. In one embodiment, composition rules data 270 specifies a limit on the length of time that summary movie data 280 takes when playing. In another embodiment, composition rules data 270 specifies one or more of the following examples: length of a highlight, number of highlights, min/max frequency of highlights in the movie (e.g., how to fill the story with representative clips), whether to include highlights from other participants MHL, whether to include media from other participants, relative weightings of the types of highlights give the signal sources and strengths, movie resolution, movie bitrate, movie frame rate, movie color quality, special movie effects (e.g., sepia tone, slow motion, time lapse), transitions (e.g., crossfade, fade in fade out, wipes of all sorts, Ken Burns effect), and many other common editing techniques and effects.

In some embodiments, all or part of the flow of FIG. 2 is run twice, first for the rough-cut and secondly for the final-cut. The first pass includes all signal data 210, processed by analyzer 215 to create tagged data 220. Tagged data 220 is processed by interpreter 225 to create a rough-cut highlight list data 240 for a rough-cut version. Media data 230 is the raw media. Extractor 245 uses highlight list data 240 and media data 250 to create rough-cut media clip data 260. In some embodiments, rough-cut media clip data 260 is used by composer 265 to create a rough-cut summary movie.

During the second pass, interpreter 225 uses rough-cut highlight list data 240 from the first pass as previous highlight list data 230. Interpreter 225 may or may not use the tagged data 220 from the first pass. Interpreter 225 then creates a final-cut highlight list data 240. Extractor 245 uses final-cut highlight list data 240 and rough cut media data 250, that is rough-cut media clip data 260 from the first pass, to create final-cut media clip data 260. Using final-cut media clip data 260 and composition rules data 270, composter 265 creates final-cut summary movie data 280.

In some embodiments, interpreter 225 is aware of whether there is media data 250 that covers the time for a given tag in tagged data 220. In some embodiments, this is achieved by iterating between interpreter 225 creating highlight data 240 and using another process (not shown) to compare the highlights with media data 250 to determine if there is media for a given highlight. This result is then used as previous highlight list data 230 and interpreter 225 is run again. New highlight list data 240 may be different than the first one given that some highlights do not have media coverage and are, therefore, given a lower weighing or discarded entirely. This embodiment can be used for the first and/or second passes described above.

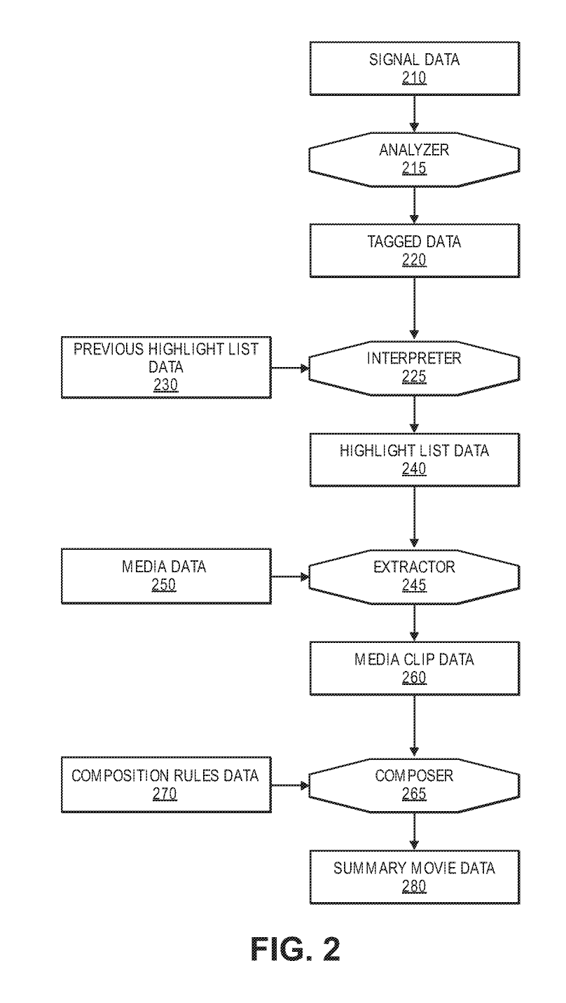

In one embodiment, all of the data used in the process is sourced and saved from one or more storage locations. FIG. 3A is a flow diagram of such an embodiment of the process for creating a summary movie. The process is performed by processing logic that may comprise hardware (circuitry, dedicated logic, etc.), software (such as is run on a general purpose computer system or a dedicated machine), firmware, or a combination of the three.

The data processing and flow of FIG. 3A are the same as that of FIG. 2, with the addition of data store 310, the location of the storage for the various operations in the data flow. Such data store 310 includes local, remote, and/or cloud data store. Referring to FIG. 3A, signal data 210, tagged data 220, previous highlight list data 230, highlight list data 240, media data 250, media clip data 260, composition rules data 270, and summary movie data 280 may be obtained from or stored in local, remote, and/or cloud data store 310. In one embodiment, the local, remote, and/or cloud data store 310 includes a single memory (e.g., RAM, Flash, magnetic, etc.) that stores and retrieves all of the data in the system (e.g., signal, tagged, highlight lists, media, clips, and composition rules). In another embodiment, the local, remote, and/or cloud data store 310 includes one or more memory devices at one or more places in the system (e.g., a local client, a peer client, cloud, removable storage). In some embodiments, long-term storage of media, signals, and highlights using cloud storage compensates for the limited and/or expensive storage on local client devices.

In some embodiments, signal data 210, tagged data 220, and/or highlight list data 240 is stored in one or more databases for random and relational searching. In some embodiments these databases are located in local, remote, and/or cloud data storage 310.

In one embodiment, each iteration through the data processing flow exploits all of the data to which the flow has access. In one embodiment, there are multiple sources of data. In yet another embodiment, some of the processes are specific to the data type and/or source. In one embodiment, some of the processes, whether specific to the data, can be duplicated and can effectively run in parallel.

A given activity may cover more than one capture session of signal and video capture. The photographer may stop or pause the capture. If the movie capture is performed on a smart phone, there may be interruptions with phone calls and other functions. Furthermore, it may be desirable to offer summary movies that cover a number of activities over a time period, say a day or a month or a year. Finally, summary movies may cover a particular activity, grouping of people, locations or other common theme. To achieve compilations of sessions the system is able to create theme compilations of master highlight lists, rough-cut and/or final-cut clips, and make compilation summary movies to express the desired theme.

In FIG. 3B, session interpreter 325 has access to the some or all of the previous highlight list data 230 of an individual user. Session interpreter 325 determines if a session should be members of a given theme. In one embodiment, session interpreter 325 directly creates the theme master highlight list. In another embodiment, session interpreter 325 starts one or more runs of a compilation interpreter 326 to create theme compilation master highlight list 340. In some embodiments, both session master highlight list 240 and theme compilation master highlights lists 340 are created. In some embodiments, only theme compilation master highlights lists 340 are created.

The determination of which sessions are relevant and involved in a compilation is a function of the theme of the compilation. For example, in one embodiment, where multiple sessions are determined to be the same activity, the time between sessions is the most relevant parameter. Looking at all sessions over a period of time (e.g. a day, a week) the time gap between sessions is calculated. Those adjacent sessions that are closer in time based on some statistic (e.g., average, sigma of the normal distribution) are considered the same activity.

In some embodiments, there is a period of time (e.g., today, this week, this month) that determines which sessions to include.

In some embodiments, there is a particular type of activity or specific theme (other than one activity or period of time) that suggest which sessions to include. Compilation interpreter 326 relies on context descriptors that can be from the signals. For example, if the theme is all sessions (and previous compilations) that show girl's soccer matches, compilation interpreter 326 might rely on detected activity type information to select soccer games (e.g., detected by their GPS coordinates mapping to a confined area around soccer fields, their originator movement is limited to that same area, their audio signals show typical patterns like crowd cheering, referee whistle, etc., flow of the players is relatively continuous, and that are of duration that's typical to soccer games such as 60 or 9 minutes). Any sessions that fit those descriptors are classified as relevant for the compilation of all girls soccer matches. In such a case, it may be possible to request the system to create, for example, a best-of soccer moments compilation for a given year.

For another example, if the theme is road biking in the Santa Cruz Mountains then the descriptors might include GPS in the Santa Cruz Mountains, 5-12 MPH up hill, 25-40 MPH downhill, constant routing, proximity to Points of Interest created by bicyclists, certain patterns in the accelerometer data, etc.

As another example, it is possible to request a compilation of the best moments spent skiing with a specific person (who is also a user of the system) during a week long ski vacation, e.g. by selecting times in the given week where the originator was in close proximity to the given person and the signal data was typical to skiing (occurred on ski runs, altimeter data spanning specific ranges, etc.)

Other examples include people, objects and activities appearing in the picture/footage, e.g., highlights containing Johnny, soccer, airplanes, dogs, etc. In one embodiment, the system adapts to new descriptors using new signal data, new methods of evaluating and processing signal data, and machine learning techniques that correlate signal data with “truth.”

In another example, it is possible to request an all times “best-of” compilation of “wipeout” while skiing by limiting to moment from the relevant activity type as demonstrated above, and choosing the highest scoring among those which exhibit accelerometer patterns indicative of a fall.

Descriptors that can be combined and weighted to determine the context that maps to a theme may include, but are not limited to, the following: activity type (e.g. deduced by learned “fingerprints” such as traveling on a trail that is usually only used for mountain biking or hiking at a speed that is too high for walking); roaming (whether the originator's movement is confined to a relatively small area, such as a playing field, or covers a larger area such as a bike ride); originator is an actor in the activity (versus a spectator deduced by means of the signals, signal amplitude/energy, etc.; “goal-oriented” activity (i.e. an activity that involves scoring goals, baskets, hits, etc. like soccer, baseball, basketball, football, water polo, etc. which may be deduced by location, voice signals, pixel histograms, etc.); indoors versus outdoors (deduced by location, voice signals, pixel histograms, etc.); location names and location type (using a GPS and a geographic database resource such as Google Places); time of day (accurate and/or binned: sunrise, morning, evening, sunset); brightness (bright/dark); contrast; color ranking (similar pixel color distribution); duration category (e.g., whether the activity performed is relatively short (<10 sec), medium (30 sec), long (>min)); moving (e.g., whether the sensor is on the originator or is stationary); recurring patterns in various sensor data, such as similarity in velocity distribution, locations traversed, etc.; shapes, objects; affordances (e.g., obtained using affordance analysis on video frames); group activity (proximity in time and location of other system users).

In one embodiment, all compilations, the highlights of the individual sessions are ranked by score, tagged by type, and selected by compilation interpreter 326. There are rules that can be set by a stakeholder (originator, intermediary, viewer) and enforced by compilation interpreter 326 that might alter the contents in the compilation highlight list. In some embodiments there are rules enforced that require representative highlights from each session be in the compilation. In other embodiments, the best highlights of sessions that would otherwise have no highlights in the compilation have their scores boosted so as to have a better chance of making the compilation. In other embodiments, there are rules that required or influence the inclusion of highlights at a representative frequency in time. For example, there might be a requirement that there be at least one highlight every five minutes. Thus, if there is a five minute period with no highlight in the compilation, compilation interpreter 326 would choose the best highlight that fulfills the requirement.

In some embodiments, the theme compilation master highlights lists are used by extractor 245 to create media clip data 260 which is in turn used by composter 265 to create summary movie data 280. In some embodiments, all the stakeholders (originator, intermediary, and viewer) can cause the creation of compilation and/or control the theme of the compilation. These compilations movies are presented to the viewer either in addition to or instead of the session movies. The embodiment of one user interface has a function that relates the sessions that contribute to the compilation associated with compilation, enabling the viewer to view some or all of the session movies as well.

If the settings and data access allow, compilations can include highlight lists and media from co-participants (see description below).

In one embodiment, the user is able to enter data to cause a search of descriptors over a database of highlights. The results of the search are processed to form the compilation movie (with a master highlight list that includes selected and not selected highlights).

In one embodiment, the user enters data via keywords (like a web search engine, e.g., Google). For example, the user could enter “Johnny” and get highlights where Johnny is identified in a descriptor. In another example, the user could enter “Johnny playing soccer” and the intersection of highlights with Johnny and soccer are identified. In the case of “soccer” (and other complex concepts), however, a combination of lower level descriptors might be used, for example “outside” and “location change <220 meters” and “flow of people (rather than stopping every play)”, and so on. Other examples include searching by “friends” lists, social networks, and specific people indicated by descriptors. Another example is descriptors that describe a particular event. For example, if fast running is described in Pamplona, Spain in early July, perhaps the event is the annual Running of the Bulls.

In one embodiment, the user selects one, or more, highlights and uses a button referred to herein as “more highlights like these.” These highlights serve as a model or prototype for the type of highlights that the user desires in the final movie. Then the search descriptors are the union, or some other combination, of the descriptors in the selected highlights.

In one embodiment, the user enters dates and times for the beginning and end of the compilation. The user can enter specific dates and times, select dates and times on a timeline, or select common phrases like “today”, “yesterday”, “this week”, “this month”, “last 60 days”, “June”, “year to date”, “location”, and so on.

In one embodiment, a combination of the above selections (e.g., descriptor keywords, example highlights, and time range) can be entered by the user.

### User Interface Gestures

As discussed above, operations are performed by a system in response to actions taken by a user via a user interface. In one embodiment, the actions are in the form of gestures performed by the user. Note that the gestures can be used at capture time, near capture time, playback, editing, and viewing. Moreover, such gestures may be incorporated as a uniform language so that when appropriate, not only can they be used in different stages of the process, but the actual gestures are similar for each corresponding action, regardless of the stage. The user performs one or more gestures that are recognized by the system, and in response thereto, the system performs one or more operations. The system may perform a number of operations including, but not limited to, tagging of media, removing previous tags, setting priority level of tags, specifying attributes of a highlight that may result from a tag (e.g., highlight duration, length of time before and after the tag point, transition before/after the highlight, type of highlight), editing of media, orienting of the media capture, zooming and cropping; controlling the capture device (e.g., pause, record, capture at a higher rate for slow motion); enable/disable meta data (signal) recoding, set recording parameters (such as volume, sensitivity, granularity, precision); add annotation to the media or create a side-band track; or controlling the display, which in some cases may include playback information and/or a more complex dashboard. These operations cause one or more effects to occur. The effect may be different when different gestures are used.

In one embodiment, effects of the gestures are adapted in real-time based on the context. That is, the effect that it is associated with each of the gestures may change based on what is currently happening with respect to the digital stream. For example, a gesture may cause a portion of a data stream to be tagged if the gesture occurs while the data stream is being recorded; however, the same gesture may cause a different viewing or editing effect to occur with respect to the data stream if such a gesture is performed on a media stream after it has already been captured.

With respect to tagging, the effect of the gesture may cause one or more of a number of effects. For example, a gesture may cause creation of a tag with a certain priority (e.g., high priority), a tag of arbitrary duration, a tag to a certain extent going backward, a tag to a certain extent going forward. A gesture(s) may cause other operations such as camera control operations (e.g., slow motion, a zoom operation) to occur, may cause a deletion of a most recent tag, may specify a beginning of a tag, may specify a transition between clips, an ordering of clips, or a multi-view point, and may specify whether a picture should be taken.

In one embodiment, the tagging controls the editing that is performed. That is, tags are included in the signal stream that leads to the creation of highlights. The user applies this type of tag during recording, or playback editing, to indicate many things. For example, an editing tag can be used to indicate a significant highlight (moment, location, event, . . . ). In some embodiments, additional or special gestures can add attributes to tags to increase the significance, indicate especially high significance, give guidance on the beginning and end of the significant highlight, indicate how to treat that significant highlight during editing (e.g., show in slow motion), alter the before and after time, and many more.

In another embodiment, the tagging controls the camera operation in real time (e.g., zoom, audio on, etc.).

The gesture language provides one or more gestures that can cause the effect that may include receiving feedback. These are discussed in more detail below

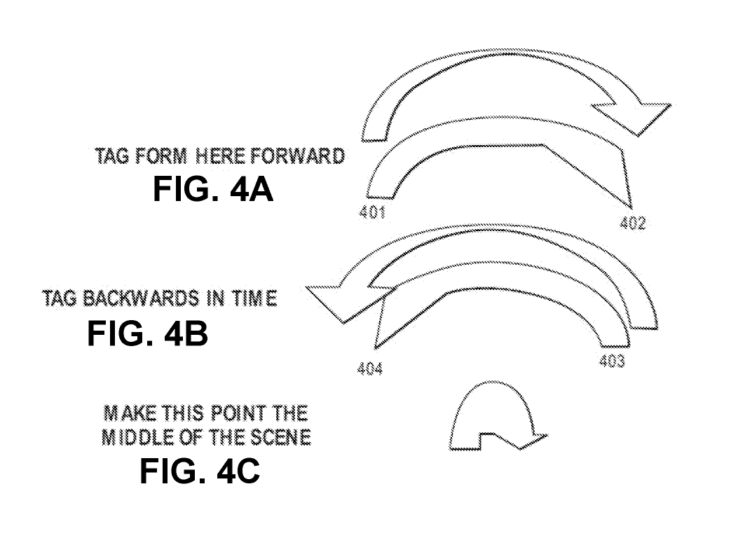

FIG. 6 is a block diagram of a portion of the system that implements a user interface (UI). The process is performed by processing logic that may comprise hardware (circuitry, dedicated logic, etc.), software (such as is run on a general purpose computer system or a dedicated machine), or a combination of both.

In one embodiment, the user interface is designed so that during an event being captured the user interface is designed to cause very little distraction. This is important because it is desirable for a participant to reduce their involvement while having the experience. In one embodiment, minimal distraction for the originator is achieved by having the application start and stop the event capture without needing specific user gesture. There is no start or stop button necessary. In one embodiment, there is no need for the user to watch the preview of the video on the screen. In one embodiment, all of the screen area is available for any gesture, and no precision by the user is required. In one embodiment, the majority of the screen is available for any gesture, and little precision by the user is required.

Referring to FIG. 6, the system includes a recognition module 601 to perform gesture recognition to recognize one or more gestures made with respect to the system and an operation module 602 to perform one or more operations in response to the gesture recognized by gesture recognition module 601. In one embodiment, operation module 602 includes a tagging module that associates a tag in real-time with a portion of a data stream recorded by a media device, in response to recognition of the one or more gestures. In such a case, the tag may be used in subsequent creation of an edited version of the stream.

The gestures may be made by a user's body part (e.g., finger). These movements of the user may be captured by sensors that are part of a touchscreen display of the system and the data may be used by recognition module 601 to determine one or more gestures and, thus, a user's desired action(s). The gestures could be made by a cursor control device moved by a user. The recognized gestures may control navigation and/or editing as described in more detail below.

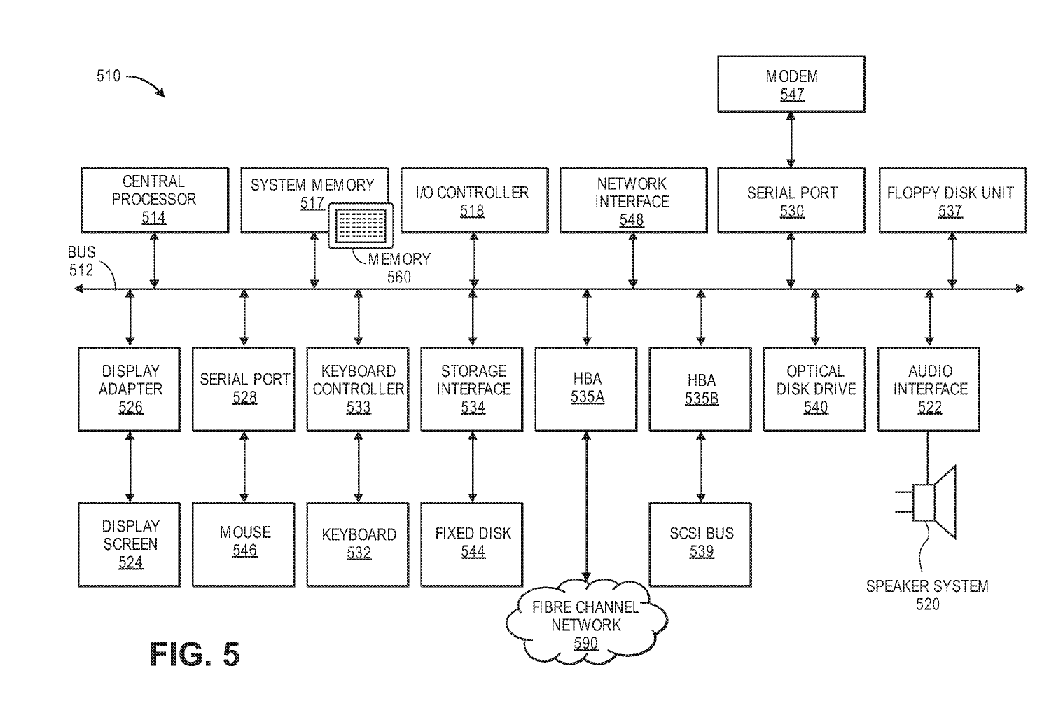

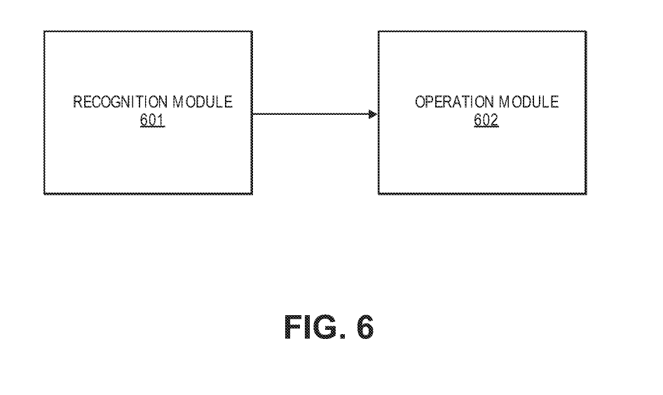

FIG. 7A is a flow diagram of one embodiment of a process for tagging a real-time stream. The process is performed by processing logic that may comprise hardware (circuitry, dedicated logic, etc.), software (such as is run on a general purpose computer system or a dedicated machine), or a combination of both.

FIG. 7A, is an embodiment of the real-time capture implementation of the system. The process begins by recording the stream with a capture device (e.g., smart phone, etc.) in real-time (processing block 701). In one embodiment, the real-time stream is a video. In one embodiment, the media device records the real-time stream as soon as an application that controls the capture on the capture device has been launched. In one embodiment, the process further comprises stopping the real-time stream recording automatically without a user gesture (e.g., user places capture device down). In this manner, there is no gesture needed to start and stop the capture process (and optionally the initial editing process).

Next, processing logic recognizes a gesture made with respect to the system (e.g., capture device (e.g., smart phone) (processing block 702). In one embodiment, at least one gesture is performed without requiring a user to view the screen of the capture device. In one embodiment, at least one gesture is performed using one hand. In one embodiment, at least one gesture is performed by pressing on the screen of the capture device and performing a single motion or multiple motions. In one embodiment, at least one gesture is captured, at least in part, by the display screen of the capture device.

The type of gestures available for a given embodiment is a function of the hardware, software, and operating system of the device. Note that a huge and growing variety of gestures can be recognized. A system that determines how hard the screen is pressed can represent different gestures. Certain devices have different sensors that can be held and/or optical sensors that recognize gestures. These types of gestures, and new gestures that emerge in the future, can be incorporated and mapped to functions in various embodiments of this system.

In one embodiment, the gesture comprises one selected from a group consisting of: a single tap on a portion of the system, a multi-tap on a portion of the system, touching a portion of the system for a period of time, touching a portion of the system and swiping left, touching a portion of the system and swiping right, swiping back and forth with respect to the system, moving at least two user digits in a pinching motion with respect to the screen of the system, moving an object along a path with respect to the screen of the system, shaking or tilting the system, covering a lens of the system, rotating the system, tapping on any part of the device, and controlling a switch of the system to change the system into an effect mode (e.g., silence mode). The system may also interpret each of the tap touch and swipe actions differently depending on whether a single finger, or multiple fingers are used simultaneously.

In one embodiment, at least one gesture enables a user to transition back in the data stream to add a tag while continuing to record the data stream. In one embodiment, at least one gesture recognized by the user interface causes a tag associated with the data stream to be deleted. In one embodiment, at least one gesture determines whether a tagged portion extends forward or backward from the tag. In one embodiment, at least one gesture recognized by the user interface causes a transition between different tagged portions of the data stream. In one embodiment, at least one gesture recognized by the user interface causes an ordering of different tagged portions of the data stream.

In one embodiment, at least one gesture recognized by the user interface causes an effect to occur while viewing the data stream. In one embodiment, at least one gesture recognized by the user interface causes a capture device operation (e.g., zoom, slow motion, etc.) to occur with respect to display of the data stream.

In one embodiment, processing logic optionally provides feedback to a user in response to each of the one or more gestures (processing block 703). In one embodiment, the feedback occurs in real-time, i.e., there is a media feedback, to the user interface operator. In one embodiment, the feedback is in the form of displaying something on a screen (e.g., one or more banners) or other indications for the duration for the tag; displaying a timeline (e.g., a film strip that may show tagged duration (including backwards)), displaying a circle under a finger expressing a tag duration (including the pass), displaying vectors forward and backward indicating a number of seconds, displaying a timer showing a countdown, displaying one or more graphics, displaying screen flash, creating an overlay (e.g., dimming, brightening, color, etc.), causing a vibration of the capture device, generating audio, a visual presentation of a highlight, etc.

While recording, processing logic tags a portion of the stream in response to the system recognizing one or more gestures to cause a tag to be associated with the portion of the stream (processing block 704). In one embodiment, the tag indicates a point of interest (e.g., a famous location) that appears in the video. In another embodiment, the tag indicates significance (e.g., forward, backward) with respect to the tagged portion of the data stream. In yet another embodiment, the tag indicates directionality of an action to take with the tagged portion of the data stream with respect to the tag location. The tag may specify that a portion of the stream is tagged from this point backward for a predetermined period.

In one embodiment, the capture device recording the streams could be different than a device recording the tags, or that the tags can be additive or subtractive from one stage to another. In one embodiment, where a single raw recording may generate multiple rough-cuts and final-cuts, the various tags generated by the various tagging devices associated with the various stages may generate multiple lists of corresponding tags.

In one embodiment, one of the tags signifies a tagged portion of the data stream is of greater significance than another of the tags. In one embodiment, the tag signifies a beginning of a tagged portion, wherein the tagged portion extends forward for a predetermined amount of time. In one embodiment, the tag signifies an endpoint of the tagged portion, wherein the tagged portion extends backward for a predetermined amount of time from when the tag occurred. In one embodiment, one or more gestures determine duration of the portion. In one embodiment, the tag signifies a midpoint within the portion of the data stream.

In another embodiment, tagging the stream comprises specifying an event that is to occur in the future, wherein specifying the event occurs prior to recording the data stream, and tagging the data stream while recording the data stream at the time of the event. In one embodiment, the event is based on time. In another embodiment, the event is based on global positioning system (GPS) information or location information associated with a map. In yet another embodiment, the event is based on measured data that is measured during recording of the data stream.

In one embodiment, tagging a portion of the stream occurs only after the one or more gestures and occurrence of one or more signals. In one embodiment, the one or more signals including one or more sensor related signals from sensors, such as those described above.

After tagging one or more portions of the stream, in one embodiment, processing logic performs editing of the real-time stream (processing block 705). In one embodiment, the processing logic performs editing of the real-time stream while recording the real-time stream using tag information. In this manner, the tag is used for the subsequent creation of an edited version of the stream.

In one embodiment, the process further comprises logging information indicative of each gesture that is used (processing block 706) and optionally performing analytics using the logged information (processing block 707), optionally performing machine learning based on the logged information (processing block 707), or optionally modifying a user interface for use in tagging the data stream based on the logged information.

The operations performed by a system may change based on the current context. For example, when tagging a data stream, a gesture may cause a particular operation to be performed. However, in the context of editing, that same gesture may cause the system to do a different operation or operations. Thus, in one embodiment, the process above includes adapting an effect of one or more gestures based on context. In one embodiment, the context is an event type. In one embodiment, adapting the effect comprises changing an amount of time associated with one or more tags associated with the data stream. In another embodiment, adapting the effect comprises changing an effect of one or more gestures with respect to a tag depending on whether the one or more gestures occurs during at least two of: recording, after recording but prior to viewing, during viewing, and during editing. In another embodiment, the process includes adapting an effect of one or more gestures based on a change in conditions. For example, a gesture made while the capture device is stationary may result in a highlight of certain duration while the same gesture made while the capture device is panning may cause a highlight of a different duration. As another example, a gesture made while watching a soccer game may result in a different highlight than the same gesture made while cycling.

In some embodiments, changes of context can happen within the recording of a session. For example, if a change in context is detected from walking to the ballpark to watching the game, the start time and length applied to tags may change, e.g. in baseball, extend the trailing time to allow tagging the batting moment, or extend the leading time to capture the play while tagging at the end of the play.

In one embodiment, the gestures can be used to pre-tag video based on sensor (e.g., GPS) or map data. For example, the user does not need to be involved in tagging if the system knows that it is near a “hot spot” and causes tagging to occur even without the user's input.

In one embodiment, the user interface described herein enables voice commands to be used.

FIG. 7B shows the same user interface gestures performed on a replay of the media after capture. Play back function 710 replaces record function 701. Also, there is no capability for editing the real-time stream of media 705. And, using the player, the movie playback can be manipulated (e.g. fast-forward, fast-backward, scrub to a time) to get to the point of the movie where the user wants to apply new tagging. Otherwise, all the functionality for gesturing, effects, and user feedback are present.

Note that the play back may be on a different device than the original video or gesture capture. For example, if the gestures and the video are captured on a smart phone that is held in the user's hand and has a touch screen. In one embodiment, the playback is on a personal computer, such as a laptop, without a touch screen. The gestures would then be different between the two. However, there is a logical and complete mapping of the gesture languages between the two devices.

The tagging device may be different than the device that is recording or processing the video. For example, the user may hold a remote control to perform the tagging. Such remote control may be a dedicated device (such as a camera remote trigger or a monitor or television remote) or a software connected device (such as a smart phone with an application to generate the gesture commands to be recorded alongside the capture or the viewing device)

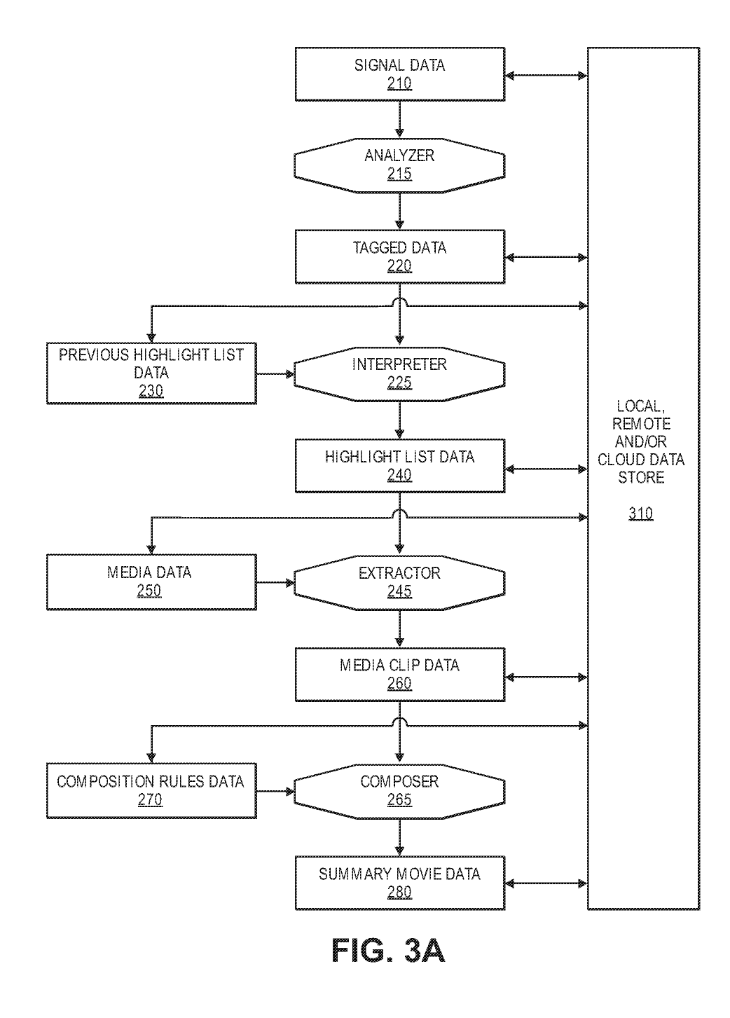

In one embodiment, user based manual input comprises the pressing of one or more buttons on the display screen to indicate a segment of interest to the user in the video stream. In one embodiment, the user based input for tagging comprises a user interface by which a user indicates the tagging location by pressing on the screen and performing simple motion. For example, the user may press a location on the screen indicating to the capture system (or viewing client) that a tagged event is occurring now, may press on the screen and drag their finger to the left to indicate to the capture system that a tagged event just ended, or may press the screen and draft their figure to the right to indicate to the capture system that a tagged event just started. Moreover, the relative length of the drag, and whether the user drags and lifts or drags and presses, may indicate to the system how long it should record such clip. FIG. 4 illustrates an example of thumb (or finger) tagging language. Referring to FIG. 4A, the user's thumb is pressed at point 401 and moved forward to the right of location 402 to indicate a particular segment being tagged where the segment starts where the thumb is initially pressed (or a predetermined amount before that location (e.g., 10 seconds of sides before that time) and the end of the tag going forward is at the point the thumb is lifted (or a predetermined amount of time (e.g., 10 seconds) after that point in the video segment. Similarly, in FIG. 4B, a user presses their thumb and moves it from point 403 to the left to point 404 to indicate that the segment to tag is from there back a certain amount of time (e.g., 20 seconds). Lastly, in FIG. 4C, a user presses their thumb on one point to indicate yet another tag in which the tagged segment extends both forward and backward from the point.

In one embodiment, tagging is performed automatically by a system. This may be based on external sensors, which include, but are not limited to: location; time; elevation (e.g., inflection point in elevation, inflection point in direction, etc.); G-Force; sound; an external beacon; proximity to another recording device; and a video sensor. The occurrence of each of these may cause content in the video to be tagged.

In another embodiment, the automated inputs create that tag events in the video stream capturing the activity are based on pre-calculated data. In one embodiment, the pre-calculated data is based on machine learning, other non-ML algorithms (e.g., heuristics), pre-defined scripts, a user's preference, a viewing preference, and/or group-based triggers. With respect to machine learning, manual inputs are applied based on previous behavior recorded into a machine learning system. These behaviors may be occurring during viewing and/or recording. With respect to pre-defined scripts defining pre-calculated data upon which to tag the video content, such scripts may come via importing (from others) or generating such scripts based on repeated actions (e.g., the same bike trip over and over again). Group-based trigger indicators are trigger indicators that are based on preferences of group (e.g., friends, family, like-minded users, location, age, gender, manual selection of user, manual selection of other users, analysis of other user's preference, “group leaders” and influencers, etc.), or trigger indicators that arise from relation between group members (e.g., two people coming close to one another may trigger a tag that will result in proximity-based highlight).

In one embodiment, tagging is performed based on adaptive and dynamic configuration of an auto-tagger. For example, the context is identified and thereafter a remote server (e.g., a cloud device) or another device configures the device dynamically.

In one embodiment, the user based manual inputs comprise of multiple types of inputs that function as a tagging language to identify segments of the video stream of interest to the user. In one embodiment, the multiple types of inputs include where the inputs can be more specific instructions, such as in cases, for example, a point of interest, directionality (e.g., the left side of me, the right side of me), importance (e.g., importance by levels, importance by ranking (e.g., a star system), etc.) and tagging someone else video (in case of multiple inputs). In another embodiment, the multiple types of inputs include where the input can be via several buttons (soft or hard) or a different sequence of pressing a single button (e.g., pressing a button a long time, pressing a button multiple times (e.g., twice)).

In one embodiment, the user input to cause tagging is an audio manual input. For example, the user may press a key to cause an audio input to be generated and that audio input causes content in the video to be tagged.

### Additional Editing Operations

There are a number of alternative embodiments with respect to the editing that is performed on different video streams.

In one embodiment, editing comprises recording an “interest level” associated with each highlight. This is useful for a number of reasons. For example, if a video needs to be changed in size (e.g., reduced in size, increased in size), information regarding the interest level of different portions of the video may provide insight into which portions to add or remove or which portions to increase or reduce in size. That is, based on external criteria, the editing process is able to modify the video stream.

In one embodiment, editing comprises reducing a physical resolution of portions of the video stream that are not associated with tags. In one embodiment, editing comprises inserting tag points into the video stream. The tag points indicate a segment of the video that has been tagged, either manually or automatically.

In one embodiment, the editing includes combining multiple camera angles (multiple sources) into a single video stream. This editing may include automated video overlapping and synchronization of multiple events (e.g. same location, same time, same speed, etc.).

In one embodiment, editing comprises reordering highlights, including and excluding highlights, selecting and applying transitions between highlights, and/or applying NLE (Non Linear Editing) techniques to create edited video content.

In one embodiment, the editing includes overlaying information on the video (e.g., a type of viewpoint), such as, for example, speed, location, name, etc.

In one embodiment, the editing includes adding credits, branding, and other such information to a video version being generated.

### Human Moments and Highlights

Traditional movie editing is focused on time. The movie starts at some point and contains a collection of scenes that have an extent and order. Significant effort is required of the editor, even with state-of-the-art software, to select and trim the clips that go into a movie and to organize them seamlessly on a timeline. Given this effort, it is unusual for this movie to be edited more than once. Thus, in such cases, the viewer only watches the one edited final cut version of the movie.

Likewise, traditional movie playback is based on time. The viewer may navigate the movie by skipping forward or reverse in time, scrubbing in time, or fast-forward and reverse in time.

However, the human viewer and the human editor do not think in time. They think in memories, or moments, that they want to view or portray. The order of appearance of these moments is implied from the context or storyline, e.g. a chronological account of events may imply chronological ordering and a best-of compilation (such as 10 fastest ski runs) may imply ordering by some measurable quantity (such as speed). They may want to include these moments and navigate based on these moments. The embodiments of this system automatically create highlights that map to the moments or memories that people what to present and view. This automatic highlight generation combines a number of signals (described above) to better map the high points of a person's experience as opposed to time.

Libraries of highlights are created over time by an individual, a family, or an affinity group. Each highlight contains time, duration, and pointers to representative media (multiple viewpoints of video, audio, still imagery, annotation, graphics, etc.). More importantly, each highlight can have context created by signals and other content. For example, each highlight can have location, acceleration, velocity, and so on. Each highlight can have descriptors and other information that help organize them by context and theme.

Given these libraries of highlights, editing of a movie for a human becomes more of a search task than a temporal video editing task. For example, an editor (and more interestingly a viewer) can search for the highlights of an activity, or of a day, or a “best of” list for a type of activity (e.g. best snowboard jumps, best family moments), or any other of a number of searches. The results of these searches are collections of highlights or highlight lists.

Each highlight list can be presented as a “movie”. In one embodiment, the automated presentation of this highlight list includes a subset of the highlight list that fit in the target duration (set by, for example, the viewer or by algorithm) and “tell the best story” (with a beginning, middle, and end and highlights that show representative portions of the story).

Given that each “movie” is created by searching over the available highlights and other viewer selected parameters, it is appropriate to expand the concept of “final cut movie” to “viewer cut movie”. Each movie is potentially an ephemeral creation of the viewer interacting with the system at a given moment. Changes in search or other parameters potentially yield different movies. Below are descriptions of how a viewer can take advantage of the highlight based viewer cut movies for more intuitive and simplified navigation and editing.

In one embodiment, a viewer cut movie is a final cut movie automatically created by searching and collecting highlights and setting parameters on the movie viewing (e.g. target duration).

### Playback Navigation Operations

In traditional movie players affordances are made for fast-forward (fast-reverse) with one or more speeds, or skip forward (skip reverse) by one or more time increments (e.g., 10 seconds, 30 seconds), or scrub forward (scrub reverse) along a timeline. This control is all linear-time-based with a single movie. In embodiments, the discrete nature of the highlights can be exploited for navigation. That is, the system has knowledge of the time extent of each individual highlight which creates the affordance of highlight-based navigation that better matches the recollection modality of the human being, which is much more anecdote-based than temporal. Essentially, the viewer cut movies are a sequence of highlights combined with appropriate transitions and annotation(s). Highlights are often of different durations. With the knowledge of the highlights, highlight order, and highlight duration, the system enables the user to navigate forward or reverse by one or more highlights.

In some embodiments, the fast-forward and reverse, skip-forward and reverse, and/or scrub functions cause fast, skip, and/or scrub across highlights rather than time. In some embodiments, a swipe to the left skips forward and starts playing the next highlight. Likewise, a swipe to the right skips reverse and starts playing the previous highlight. These functions work in the full screen player mode (where there are no markings over the video screen) as well as in the instrumented player mode (where affordances like, for example, the scrub timeline, play/pause button, and fast forward and fast reverse buttons are visible).

In one embodiment, a gesture such as double tap on the right side causes fast forward where only a few frames of each highlight is played before moving to the next. Double tap on the left side causes fast reverse where only a few frames of each highlight are played before moving to the previous highlight. These functions work in the full screen player mode (i.e., the movie takes the entire screen area of the device with no overlays) as well as in the instrumented player mode (i.e. where the movie has an overlay with control buttons and sliders and information). In some embodiments, the fast forward and fast reverse buttons in the instrumented mode forwards or reverses the movie by highlight increments, rather than time, displaying only a few, or no, frames per highlight before going to the next highlight.

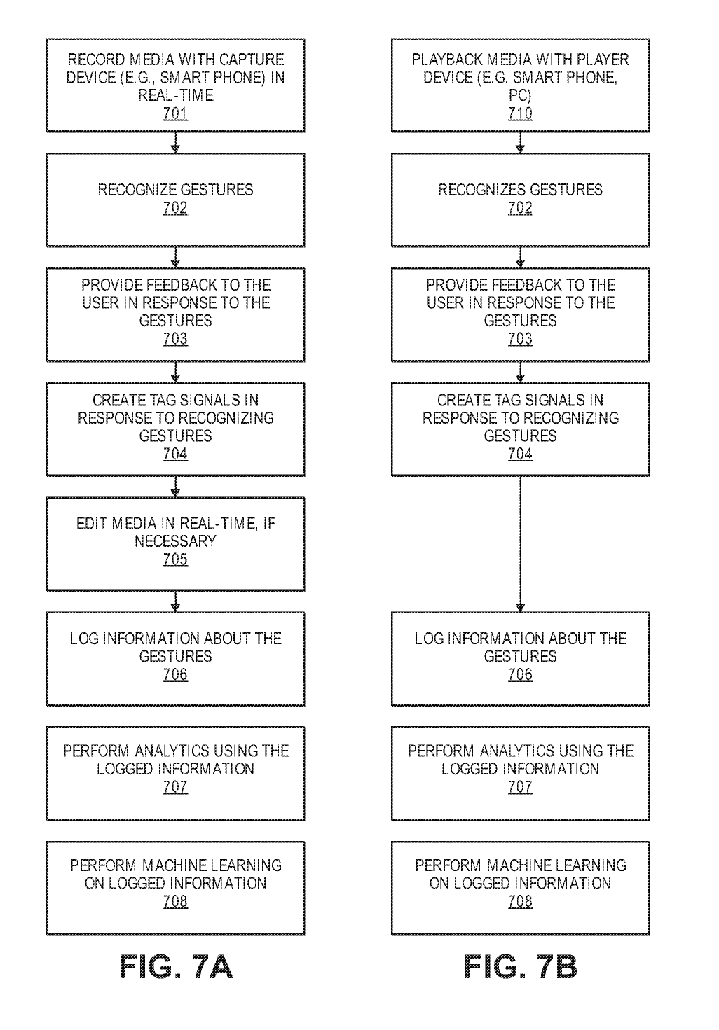

FIG. 9 shows the traditional timeline 901 that is commonly used for the traditional scrub function. Referring to FIG. 9, the highlight line 902 shows a depiction of not only time but also individual highlights. In one embodiment, a common scrub gesture (holding down and moving along the highlight, not time, line) moves between highlights. In this case, the scrubbing position aligns the movie position to the beginning of a highlight. In one embodiment, this function requires the instrument mode with a representation of the movie indicating highlights. In one embodiment, the user merely taps the highlight to move to that highlight.

A movie may be generated by re-encoding all the highlights, thereby creating a new single contiguous movie. Alternatively, movie playback may actually be achieved by playing a number of movie clips (from raw, rough, or final cut) one after another. In either case, all of the above embodiments of navigational operations are employed.

In one embodiment, the user is presented the option of performing the fast forward and reverse, skip forward and reverse, and/or scrub functions along either the timeline or the highlight line. In one embodiment, the gestures for the timeline are different than the gestures for the highlight line. In one embodiment, the user selects which line (timeline or highlight line) to use either in profile presets or with a button selector.

In one embodiment, the difference between playback tagging and playback navigation is by user choice. In one embodiment, the user selects the instrumented for playback tagging and the normal viewing mode for navigation. In some embodiments, the gestures are specific for tagging or navigation. In one embodiment, the result of any tagging gesture causes some tagging feedback while the result of a navigation gesture is simply to navigate to that point.

In one embodiment, all of the navigational operations of the viewer (or stakeholder) are recorded as analytics and used by various machine learning algorithms to improve the automated presentation of viewer cut movies.

### Non-Temporal Editing

Traditional movie editing systems require the user to manually navigate the raw movie, determine the clips and the trim (beginning and end of the clips), arrange them temporally, and set the transitions between the clips. In one embodiment, the clips, trim, and transitions are automatically determined or are determined in response to simple manual tagging gestures.

In one embodiment, the editing and/or navigating is performed by a Player. The Player may be a mobile device (e.g., smartphone, laptop, etc.) or other computer system. In one embodiment, there are two types of input to the Player, the media content consisting of one or more files with raw, rough, and/or final cut media, and the Master Highlights List (MHL) which is presented either as a file, object, and/or database entries in different embodiments.

In one embodiment, the MHL contains metadata about the highlights, media, and the movie to be presented and includes the “recipe” for creating movies either in real-time (on the fly) or for export to conventional movie files.

In one embodiment, among other things, for every highlight the MHL describes the start time, end time, media location (e.g., filepath, URI, etc.), position in the movie, and whether the highlight is selected to be visible in the movie. (In one embodiment, the MHL refers to all the highlights associated with a movie whether or not the user has selected a specific highlight to be visible.)

In one embodiment, the Player uses the information in the MHL to automatically “point to” or “extract” media according to the highlight information. If the user navigates around the movie, the Player knows the highlight time boundaries and can forward or reverse by some number of highlights. Likewise, if the user edits the movie or highlights using the Player (e.g., by changing the order of presentation, adding or removing highlights, or trimming or expanding highlights) that information is recorded in the MHL and a “new” movie is created.

There are several possible embodiments of the Player. Below are three example embodiments meant to illustrate the diversity possible. The first example embodiment uses the AVFoundation frameworks from Apple Inc. These work with most modern Apple hardware products including the Macintosh computers, iPad tablets, and iPhone smart phones. Using a subclass of this framework, called the AVMutableComposition (and its subclasses like AVMutableVideoCompositionlnstruction, and AVCompositionTrack), a movie is “created” with a list of programmatic references to the media. Two video tracks are created. The odd positioned highlights are referenced in one track and the even are referenced in the other. The Player translates the highlight media, start and end times, and position into these framework objects. Furthermore, the transitions (e.g., crossfade, fade to black, etc.) between the highlights are programmed into these objects. (Note that audio is treated the same way in separate audio tracks.) When these objects are presented to an AVPlayer, the movie is played as expected. Note that the objects created by the AVFoundation frameworks do not have the sense of highlights. When navigating the movie and/or highlights, the Player has logic that determines the appropriate highlight boundaries from the MHL and repositions the player automatically. When editing the highlights, the Player has logic that determines which highlight to edit and which media to present and then modifies the MHL. Then a new AVMutableVideoCompositionlnstruction is created from the now edited MHL.

Another example embodiment of the Player starts with the same framework objects as stated above. However, in this case, the objects are presented to the export function rather than the AVPlayer function. Thus, a conventional movie (flattened) is created with all the highlights strung together with the transitions. This movie can now be played on any conventional player (compatible with the export file format, e.g. MPEG 4). Additionally, the MHL itself is added to the movie (slightly modified to point to the media in the movie itself rather than the raw or rough cuts) as metadata. Thus, if the Player is used instead of a conventional player on this flattened movie file, the MHL is read and the Player can offer the same navigation and editing functions as the previous embodiment.

In the last example embodiment, the movie is converted into a streaming format, such as, for example, an HTTP Live Stream. The Player uses the MHL information to determine how to extract and transcode the media corresponding to each highlight. In one embodiment, a codebase such as the above described AVFoundation or, alternatively, the popular open source, FFMPEG project can be used to execute the media extraction and transcoding. (Note that if crossfade transitions between highlights are needed, those also are created as separate files.) Then an M3U4 file is created for a conventional HLS player. All of these files, plus the MHL, is placed on an HLS ready server (e.g., Amazon Web Service's S3 repository). A conventional HLS player can stream the movie as usual. However, the streaming Vieu Player downloads the MHL and can navigate or “edit” the movie as before. Navigation is performed by changing the order of downloading of the streamed media files (at least until all the relevant media has been downloaded when navigation can, once again, be locally controlled). In one embodiment, the editing interacts with local media files and creates a new M3U8 file (and uploads new streaming media as required). In another embodiment, the editing creates a series of “instructions” that are relayed to a “Streaming Server” (via API for example) and the Streaming Server creates a new set of streaming files from using the original media files.

In one embodiment, the viewer cut movies are generally time constrained. In one embodiment time constraints such as desired duration, maximum duration, number of highlights, etc., are set by the stakeholder (e.g., originator, editor, viewer) as a default, for each movie, for different types of movie, per sharing outlet (e.g., 6 seconds Vine, 60 seconds Facebook), target viewer, etc. In some embodiments, the time constraints are machined-learned based on the viewing actions (e.g., how long before the viewer quits the movie) of the viewer.

In many cases, there are far more highlights detected that can fit within the time constraints. For example, there might be 120 seconds of highlights with a final cut movie might be limited to 30 seconds. In some embodiments, the existence of additional and/or alternate highlights is presented to the viewer, for example, with an onscreen icon.

In one embodiment, the user is given the affordance to remove (demote) highlights from the final cut. In one embodiment, a swipe up gesture signals the system that the current highlight is to be removed.

In one embodiment, the user is given the affordance to add (promote) highlights into the final cut. In one embodiment, a visual display of highlight thumbnails representing available, but not included, highlights is shown. The user selects the highlight(s) to be included in the final cut but touching the thumbnail. In one embodiment, the user is offered a “mosaic”, or gallery, display of the highlights in display order with a checkbox. The user can select or unselect the checkbox to add or remove the highlight from the movie presentation. Note that this does not delete the highlight; it merely unselects it for presentation.

In another embodiment, the highlights are presented on the timeline in the instrumented mode and the highlights that are included are taller than the ones that are not (or, alternatively, bolder or presented differently on the display). The user can select or unselect with a swipe up or swipe down.

In one embodiment, the highlight thumbnail is a still image from the highlight and it may be possible to play part, or all, of the highlight by interacting with the thumbnail (e.g., touching it briefly or swiping the finger across it). In some embodiments, the highlight thumbnail is a movie, or animated, depiction of the highlight. In one embodiment, the highlight plays in a pop-up window above the screen that presents all the highlights. This is intended to inform the user that only one highlight is playing and point to which one.

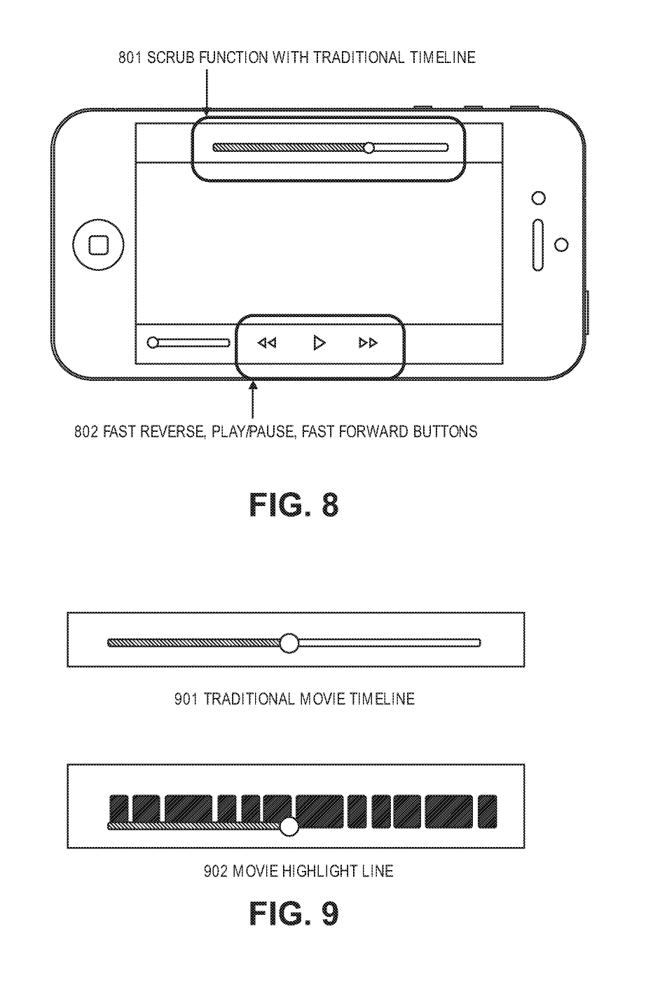

In one embodiment, the highlight thumbnails are arranged in a regular array (referred to herein as a mosaic) as shown in FIG. 10A. In one embodiment, the highlight thumbnails are arranged in an irregular array and are different sizes, such as shown, for example, in FIG. 10B. The differences in sizes are random in some embodiments while in another embodiment the larger size represents a more important (e.g., higher relative score). In one embodiment, the user can scroll through a number of highlights when there are too many to put on the screen.

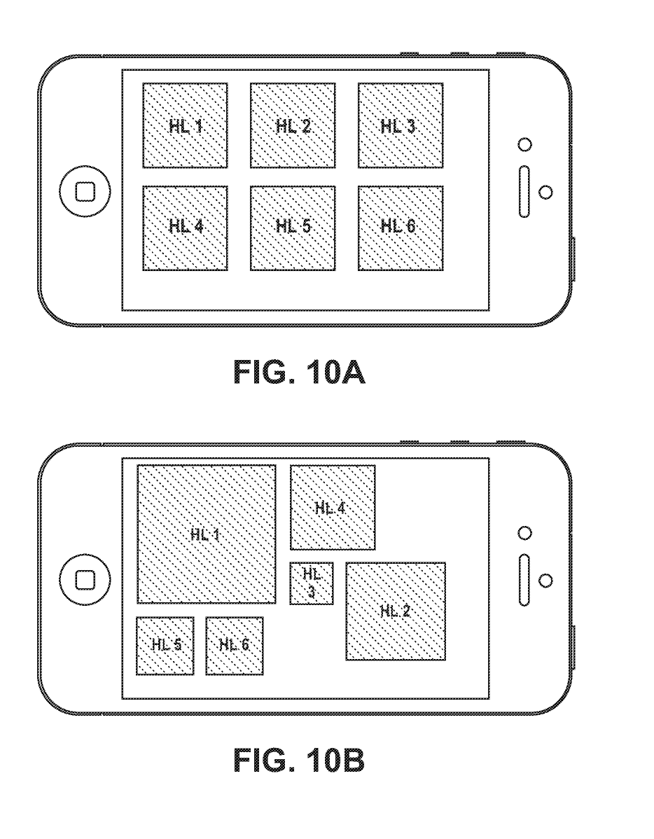

In one embodiment, both the “included” and the “available but not included” highlights are presented, as shown in FIGS. 11A and 11B. In one embodiment, the “included” highlights are slightly saturated in color (faded), grey level rather than color, surrounded in a boundary, and/or some other visually distinguishing characteristic. In other embodiments, it is the “available but not included” highlights that have the visually distinguishing characteristic. In one embodiment, the user can touch the highlight to change its status (i.e., included to not included or not included to included).

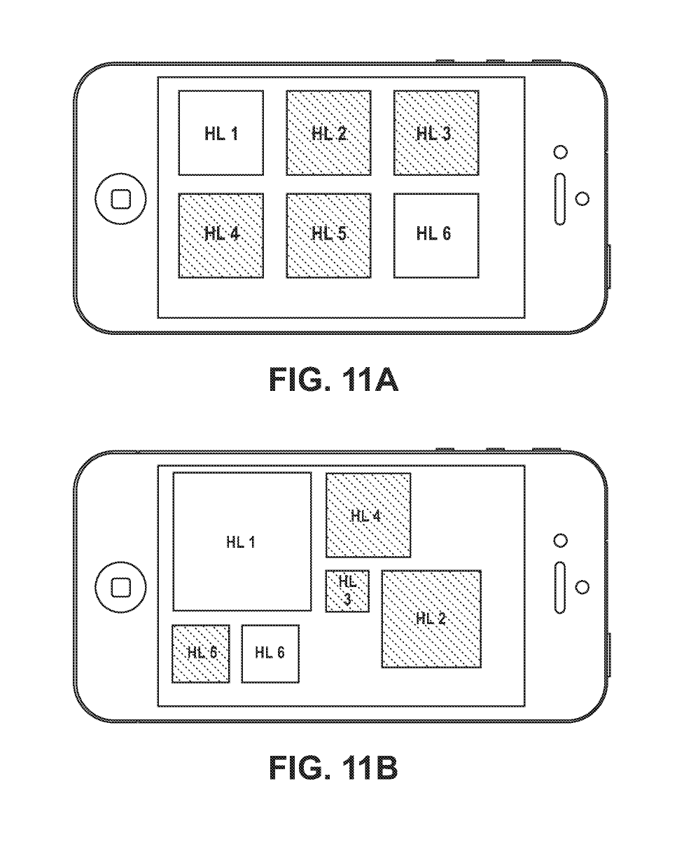

In one embodiment, the included or selected highlights are shown with a checkmark in a checkbox shown in FIG. 12 or another type of visual mark to indicate it has been selected. Likewise, the “available but not included”, or not selected highlights, are shown with an empty checkbox or another visual mark to indicate they have not been selected.

In one embodiment, a swipe down gesture during the playback of a movie launches the promotion (or promotion/demotion) page of highlights. In one embodiment, the page of highlights is presented at the conclusion of playing the movie.

In one embodiment, all of these operations of the viewer (or stakeholder) are recorded as analytics and used by various machine learning algorithms to improve the automated presentation of final cut movies.

In one embodiment, the highlights are arranged by default in chronological order. In one embodiment, there is a function that enables rearranging the highlights. Many gestures, lists, or other user interface affordances can allow the user to rearrange the highlights. In one embodiment, two gestures are used that are similar to rearranging application icons on the screens of iPhones running iOS. In the mosaic page, the first gesture is a press and hold gesture that causes all the highlights to “jiggle” (vibrate in place). The second gesture is a drag and drop gesture which drags and drops a highlight into a new location. All of the other highlights move in the mosaic page to take their new place in order. The new order is preserved. In a different embodiment, a pressure sensor of the device screen senses an extra hard press and then allows the user to rearrange with the drag and drop gesture. Once again, the other highlights are rearranged to depict the new order. In yet another embodiment, the highlights are rearranged with a simple drag and drop gesture (without extra hard touch or touch and hold). Again, the other highlights are rearranged in order. In still another embodiment, touching and holding a thumbnail, either in the highlight strip or the mosaic, causes it to “pop out” of the sequence and be moved around, and letting go will cause it to drop in its new location.

In another embodiment, using a special gesture while playing the highlight (see example above) causes the highlight to “pop out”. The highlight can then be dragged beyond the trim limits. Another embodiment uses another gesture with two fingers to expose the highlight strip and allow repositioning the highlight in a different location on the strip

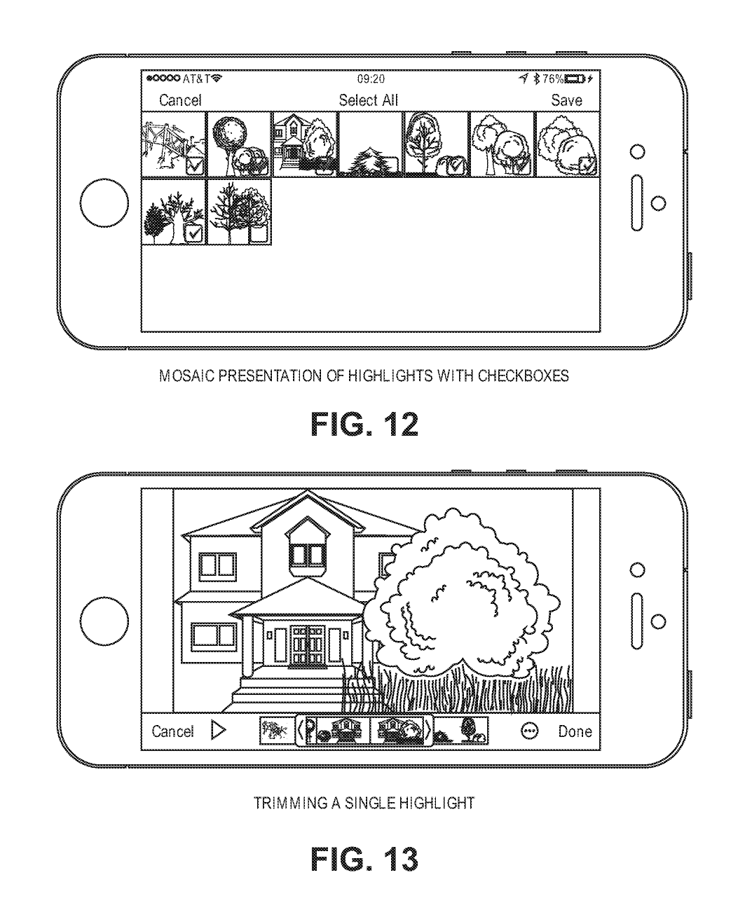

In one embodiment, the individual highlights can be trimmed. In one embodiment, the trim function is launched with a window that shows the beginning of the highlight with a traditional trim window (see FIG. 13). This trim window enables the user to change both the start time and end time of the highlight by dragging the left most and right most part of the trim window respectively. In one embodiment, the trim function is launched using a special gesture on the playing movie, such as, for example, a two finger tap or hold, which causes the playing highlight to visually pop out of the movie with additional footage on both its ends, allowing the user to drag the entire highlight or any of its ends to shift it in time and/or resize it. In one embodiment, the gesture that plays the highlight is augmented with a single tap to launch the trim function.

In one embodiment, for some highlights, in addition to trimming the highlight, the user is able to shift the window in time and expand the beginning and/or end time beyond the original beginning or end of the highlight. Using raw or rough cut media as the source for the movie, there can be significantly more media time available than just the extent of the highlight. For example, for a 10 second highlight the rough cut might start 10 seconds before and extend 10 seconds after the highlight. In one embodiment, the user is given a trim bar that depicts the rough cut with the window edges (beginning and end) set around the highlight. The user can move the window's left edge to start the highlight earlier, up to 10 seconds earlier in the above example. Likewise, the user can move the right edge to end the highlight later. In one embodiment, the user can touch the center of the trim window and shift the entire window to the left (earlier) or the right (later). Functionally, in one embodiment, the highlight is mapped to a media file. To “trim” the highlight means changing the beginning and/or end of the highlight by modifying the values in the MHL. However, many of the media files, either raw or rough cut, start before and end after the original highlight times. So the user, when editing, is allowed to expand the time to start earlier or end later, if the media covers that time.

One embodiment of the user interface has a window (signified by a yellow border in one embodiment). The left or right edges of the window can be moved toward the center (trimming the time) or away from the center (expanding the time). The window could also be dragged (scrub-style gesture) to a different time location. Thus, the duration would not change but the start and end times would (e.g., drag to the left for an earlier start, drag to the right for a later start).

In one embodiment, a “Save” button (see FIG. 12) on the mosaic screen saves the edited state of the movie presentation. That is, which highlights are selected, the order of highlights, the trim and shift offset, and other edits are recorded and preserved for return viewing or sharing (see below) of the movie. (Conversely, in one embodiment, there is also a “Cancel” button that returns the movie presentation to the original state.)

In one embodiment, the history of the edits is recorded for an undo function. This undo function is used in the current editing session, or in a later session, or even by the viewer that has received the shared version of the movie. The edited start and end times and/or inclusion/exclusion settings are recorded for the undo in the MHL data structure or file. The undo function has a data structure or file that records the original settings. When the user decides to “undo”, the original settings replace the edited ones in the MHL. In one embodiment, the levels of undo and redo are a function of the particular embodiment. In one embodiment, some or all of the edits are non-destructive. That is, the underlying rough or raw cut source media is not altered either on the client devices and/or in the cloud repository (remote storage).

### In-App Sharing of Movies

There are several embodiments for users to share videos with other viewers. In one embodiment, the user selects “traditional” sharing. In one embodiment, the system creates a traditional movie and uploads it to the device store (e.g., camera roll) or a traditional movie sharing site (e.g., YouTube, Vimeo, Instagram, Facebook, etc.). In one embodiment, the “traditional” nature of the sharing action may be inferred from the selected destination. For example, when publishing on YouTube or sending to a person that uses a player that lacks the features of these embodiments.

In one embodiment, the master highlight list information is embedded in the movie file format container as metadata. This highlight information allows a player with the features of these embodiments (navigation and editing by highlights) to access the highlights in a movie file that can also be played by a conventional digital movie player (e.g., Apple's Quicktime). In one embodiment, the MHL includes the start time, end time, rough cut file location, and display parameters (include/exclude, relative position, etc.) for every highlight in the movie. For a Player, the movie is constructed with this information and the information is preserved. Therefore, the Player is able to navigate by highlights by translating the highlight timings into movie time and using the movie time as the input to a conventional player. For example, if the first three highlights of a movie are six seconds, four seconds, and nine seconds, respectively, and the user wants to skip to the next highlight, from the first, the Player would move to the six second point in the movie. To skip to the next, it would go to the 10 second point in the movie. To skip to the next, it would go to the 19 second point in the movie, and so on.

In one embodiment, the highlight information embedded in the movie container is encrypted to prevent unauthorized or unauthenticated use of the navigation and editing features. In one embodiment, a pointer, a URI or URL, to the highlight information is embedded in the movie container rather than the actual information.

In one embodiment, the highlights are concatenated with elegant transitions (e.g., crossfade) for playing on a traditional movie player. In one embodiment, the highlights are concatenated without transitions to enable better access to highlights. In one embodiment, the rough cuts are concatenated together. In this embodiment, a player with the features of these embodiments can play the movie as selected. In one embodiment, all of the rough cuts, or final cuts, are concatenated, either in order or with the not selected highlights at the end. Once again, in this embodiment, a player with the features of the embodiment can play the movie as selected.

In one embodiment, in-app sharing is enabled by affecting the transfer of all of the rough, or final, cut clips and the master highlight list description from the sender to the receiver. In this embodiment, all of the navigation and editing features are available to the receiver of the movie. Once all the media and MHL are transferred (e.g., via APIs, cloud repository SDK software, streaming methods, etc.), then a Player on the receiver's application can interact with the movie in the same way as the originator. In one embodiment, the rough or final cuts are uploaded from the sender to the cloud repository in the order that they are needed. In one embodiment, the rough or final cuts are downloaded from the cloud repository in the order that they are needed. Highlights that are not selected to be in the movie are not downloaded until needed. In one embodiment, the person sharing can decide what operations may be available to the receiver. For example, he/she may allow the receiver to include and exclude highlights but to share with other people only the original movie they received, with their receivers able to skip highlights forward and backward (in case of in-app sharing) but without the ability to edit. In one embodiment, the order of upload is important because the receiver will be waiting until the video is available before it can be downloaded. (Note that the downloading can be either a file based protocol or any number of media streaming protocols.) For example, if the sender has a movie with five highlights and only highlight one, three, and five are selected, then, the order of upload would be one, three, five, two, four. Depending on the embodiment and the protocol, the receiver may start receiving the movie in that order after the first highlight has been uploaded. In a different embodiment, the receiver may not start receiving the movie until all the selected (visible) highlights (one, three, five) have been uploaded. In one embodiment, the rough cut segments correspond directly to the partial individual files defined by a streaming protocol (e.g., HTTP Live Streaming, HLS, etc.).

In one embodiment, the “visible” rough cut, corresponding to the selected highlights, is uploaded and downloaded first (with the capacity of doing either upload or download concurrently) in order to speed up the transfer process and reduce the time it takes for the receiver to get a playable movie.

In one embodiment, highlights are streamed, rather than downloaded, from the cloud repository to the receiver as needed. In one embodiment, the highlights are downloaded from the cloud repository in a “lazy” manner, i.e. each highlight is downloaded only when it is actually needed for display. In one embodiment, an image asset that represents the highlight is presented in a mosaic or timeline presentation of the movie. In one embodiment, a “cloud” icon is placed on, or near, the highlight image. When the user wants to play the highlight (or a movie where the highlight is selected to be visible), the video highlight is downloaded. Only when the user adds the highlight to the movie is that actual media file downloaded from the server. In one embodiment, this “lazy” download may occur which the movie is playing.

In one embodiment, the thumbnails for all the highlights (or at least for those highlights yet to be downloaded) are downloaded first, or early, in the download process. This enables the mosaic page to show all the possible highlights, even if those highlights are yet to be downloaded. In one embodiment, the “visible” rough cuts, corresponding to the selected highlights, are downloaded first. As soon as this is finished the movie is available for playback by the receiver. After that, the non-visible rough cuts, corresponding to the not selected highlights, are downloaded in the background and incrementally added to the mosaic display.

In one embodiment, the system is connected with a social network that allows viewers to “follow” the published movies of a user. In one embodiment, viewers are allowed to subscribe and/or select movies from the user to share. In one embodiment, the originator needs to approve new subscribers/followers. In one embodiment, the originator may designate criteria for which movies may be automatically shared with which followers, either on a case-by-case basis (movie & follower) and/or using more general criteria like “soccer movies only to other participants”. These, and other social network sharing affordances, are independent of the type of sharing (e.g., traditional, in-app, traditional with master highlight lists embedded). In one embodiment, all of the sharing functions are available for the originator (sender) as well. In one embodiment, movies, raw, rough, and final cuts, and master highlights lists are uploaded to the cloud repository. These may be deleted from the client device to save memory. In this case, a given movie can be recreated upon user request using the same embodiments as sharing (e.g., transferring the master highlight list, rough and/or final cuts, downloading as needed, streaming).

### An Embodiment of a System

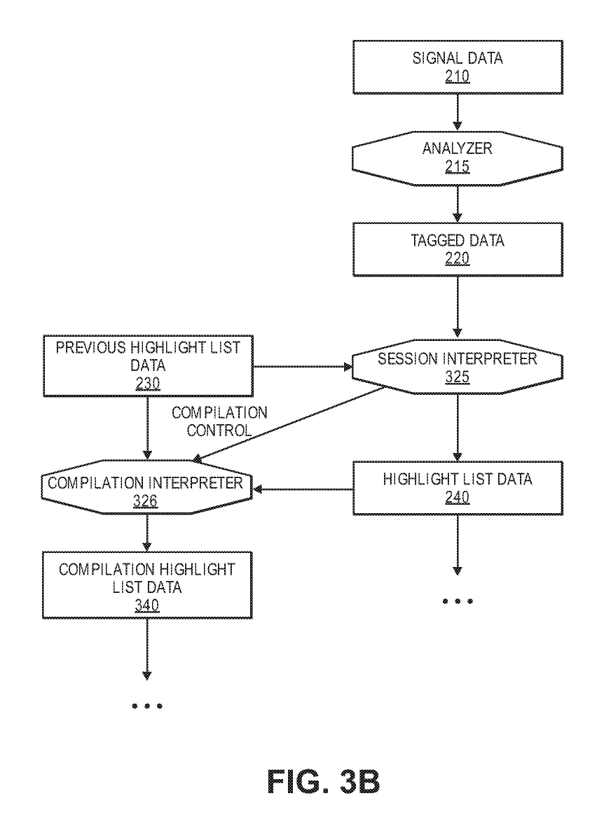

FIG. 5 depicts a block diagram of a system. Operations described above can be performed by such a system. In one embodiment, the system may be used as a storage server system. In another embodiment, the system may be the Player described above.

Referring to FIG. 5, system 510 includes a bus 512 to interconnect subsystems of system 510, such as a processor 514, a system memory 517 (e.g., RAM, ROM, etc.), an input/output controller 518, an external device, such as a display screen 524 via display adapter 526, serial ports 528 and 530, a keyboard 532 (interfaced with a keyboard controller 533), a storage interface 534, a floppy disk drive 537 operative to receive a floppy disk 538, a host bus adapter (HBA) interface card 535A operative to connect with a Fibre Channel network 590, a host bus adapter (HBA) interface card 535B operative to connect to a SCSI bus 539, and an optical disk drive 540. Also included are a mouse 546 (or other point-and-click device, coupled to bus 512 via serial port 528), a modem 547 (coupled to bus 512 via serial port 530), and a network interface 548 (coupled directly to bus 512).

Bus 512 allows data communication between central processor 514 and system memory 517. System memory 517 (e.g., RAM) may be generally the main memory into which the operating system and application programs are loaded. The ROM or flash memory can contain, among other code, the Basic Input-Output system (BIOS) which controls basic hardware operation such as the interaction with peripheral components. Applications resident with computer system 510 are generally stored on and accessed via a computer readable medium, such as a hard disk drive (e.g., fixed disk 544), an optical drive (e.g., optical drive 540), a floppy disk unit 537, or another storage medium.

Storage interface 534, as with the other storage interfaces of computer system 510, can connect to a standard computer readable medium for storage and/or retrieval of information, such as a fixed disk drive 544. Fixed disk drive 544 may be a part of computer system 510 or may be separate and accessed through other interface systems.

Modem 547 may provide a direct connection to a remote server via a telephone link or to the Internet via an internet service provider (ISP). Network interface 548 may provide a direct connection to a remote server or to a capture device. Network interface 548 may provide a direct connection to a remote server via a direct network link to the Internet via a POP (point of presence). Network interface 548 may provide such connection using wireless techniques, including digital cellular telephone connection, a packet connection, digital satellite data connection or the like.

Many other devices or subsystems (not shown) may be connected in a similar manner (e.g., document scanners, digital cameras and so on). Conversely, all of the devices shown in FIG. 5 need not be present to practice the techniques described herein. The devices and subsystems can be interconnected in different ways from that shown in FIG. 5. The operation of a computer system such as that shown in FIG. 5 is readily known in the art and is not discussed in detail in this application.

Code to implement the system operations described herein can be stored in computer-readable storage media such as one or more of system memory 517, fixed disk 544, optical disk 542, or floppy disk 538. The operating system provided on computer system 510 may be MS-DOS®, MS-WINDOWS®, OS/2®, UNIX®, Linux®, Android, or another known operating system.

### Overview of the Capture and Player System

In one embodiment, the capture system for capturing the raw video, such as raw video 101 of FIG. 1, is a smart phone device. Such a smartphone device may be the Player described above. Note that in one embodiment, the smartphone is used as the Player but not used for capture.

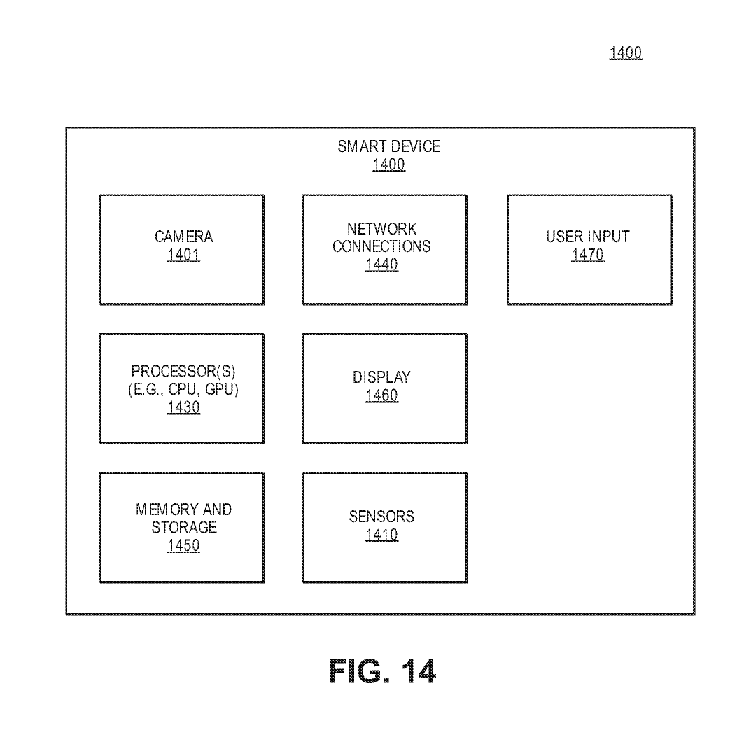

FIG. 14 is a block diagram of one embodiment of a smart phone device. Referring to FIG. 14, the smart phone device 1400 comprises camera 1401 which is capable of capturing video. In one embodiment, the video is high definition (HD) video. Smart device 1400 comprises processor 1430 that may include the central processing unit and/or graphics processing unit. In one embodiment, processor 1430 performs editing of captured video in response to received triggers (and tagging).

Smart device 1400 also includes a network interface 1440. In one embodiment, network interface 1434 comprises wireless interface. In an alternative embodiment, network interface 1440 includes a wired interface. Network interface 1440 enables smart device 1400 to communicate with a remote storage/server system, such as a system described above, that generates and/or makes available raw, rough-cut and/or final-cut video versions.

Smart phone device 1400 further includes memory 1450 for storing videos, one or more MHLs (optionally), an editing list or script associated with an edit of video data (optionally), etc.

Smart phone device 1400 includes a display 1460 for displaying video (e.g., raw video, rough-cut video, final-cut video) and a user input functionality 1470 to enable a user to provide input (e.g., tagging indications) to smart phone device 1400. Such user input can be the touch screen, sliders or buttons.

In some embodiments, summary videos are collected in the cloud and/or on client devices (e.g. smart phone, personal computer, tablet). These devices can play the movie for the viewer. In some embodiments, this player enables the viewer to manipulate the video creating new tags, deleting others, and reorganizing highlights (see the description below). In some embodiments, the originator of the summary video can share the video with one or more viewers via uploading to the cloud (or other remote storage) and enabling viewers to download from the cloud. Viewers can subsequently share the same way. In one embodiment, the cloud provides player and/or edit functions via a standard web browser. Permission to view and/or edit the video can be shared via URL and/or security credential exchange.

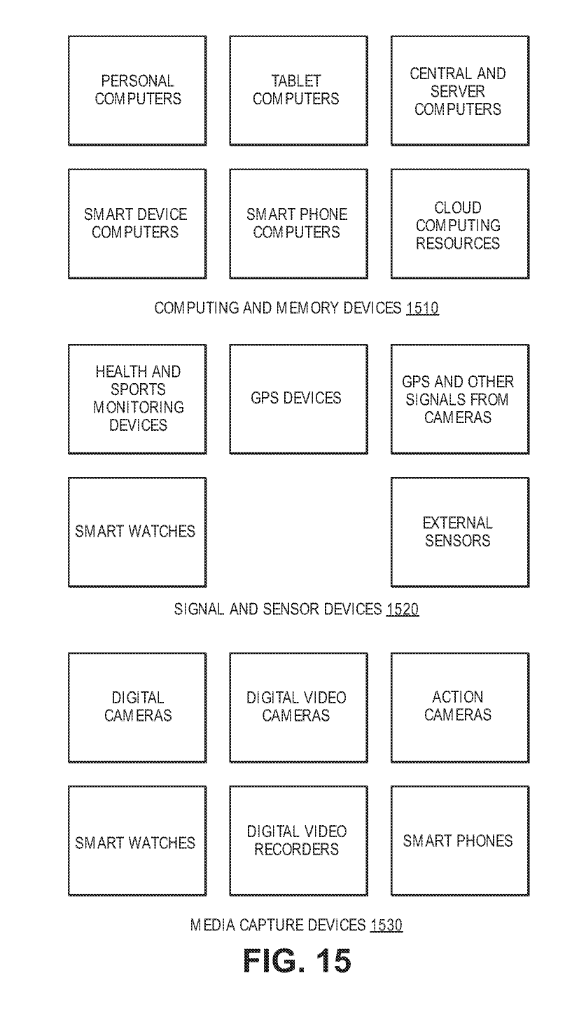

The overall system is made up of one or more devices capable of capturing signals, recording media, and computing processing and storage. FIG. 15 shows a number of computing and memory devices 1510 such as, for example, smart phones, tablets, personal computers, other smart devices, server computers, and cloud computing. A number of signal and sensor devices 1520 such as, for example, smart phones, GPS devices, smart watches, digital cameras, and health and fitness sensors can be used to acquire signals. Also, a number of media capture devices 1530 such as, for example, smart phones, action cameras, digital cameras, smart watches, digital video recorders, and digital video cameras can be used in the system. All of these can be integrated together via various forms of digital communication such as cellular networks, WiFi networks, Internet connections, USB connections, other wired connections and exchange of memory cards. The processing of a given activity can performed on any of the computing and memory devices 1510 using the signals and media that are accessible at the moment. Also, the processing can be opportunely distributed among devices to optimize (a) the locality of signals and media to avoid sending and receiving large amounts of data over limited bandwidth, (b) the computing resources available, (c) the memory and storage available, and (d) the access to participant data. Ideally, perhaps after final-cut movies are produced, the signal data, media data, and the MHL created at any point in the system would eventually be uploaded to a central location (e.g., cloud resources) so that machine learning and participant sharing can be facilitated.

In some embodiments, signal and sensor devices 1520 record audio to enable synchronization with media capture devices 1530. This is especially useful for cameras that are not otherwise synchronized with the signal and sensor devices 1520.

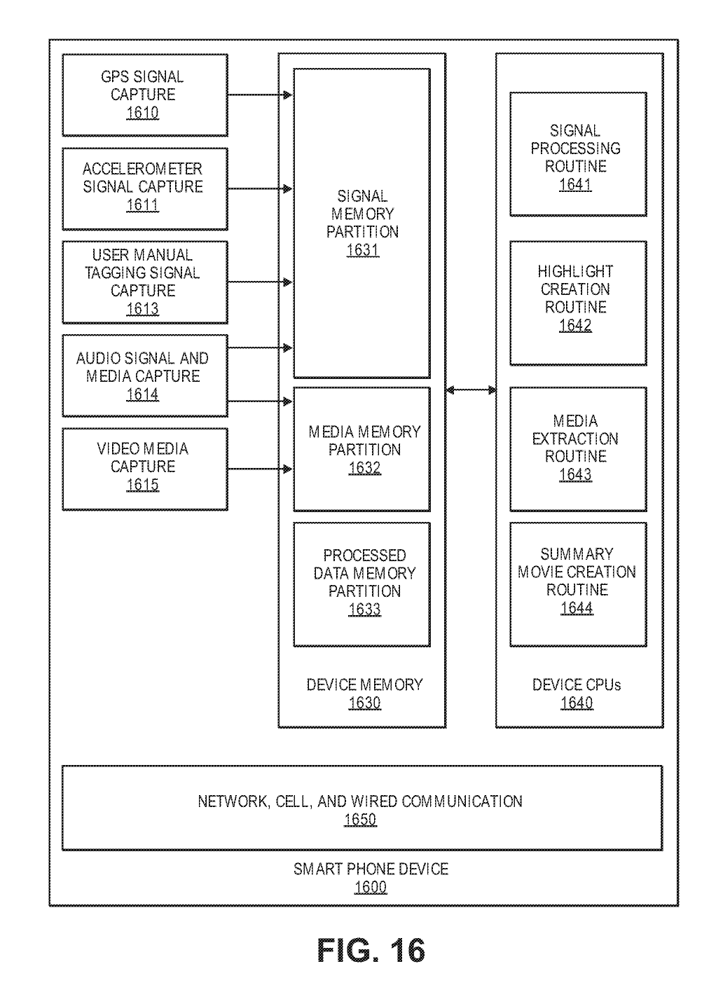

In some embodiments all of the signal capture, media capture, and processing are performed on one device, e.g. a smart phone. FIG. 16 shows a single device with all of these functions. A smart phone device 1600, such as the Apple iPhone, has dedicated hardware to capture signals such as GPS signal capture 1610, accelerometer signal capture 1611, and audio signal and media capture 1620. Using a combination of hardware and software, manual gestures (e.g. tags and swipes on the touch sensitive display, motion of the device) can be interpreted as user manual signal capture 1612. In one embodiment, smart phone device 1600 also has dedicated video media capture 1615 hardware as well as the audio signal and media capture 1614 hardware.

Using smart phone device 1600, device memory 1630, and device CPUs 1640 and network, cell, and wired communication 1650, the data and processing flow functions (shown in FIG. 6) can be performed. Note that some of these smart devices include several memories and/or CPUs to which the functions can be allocated by the implementer and/or the operating system of the device. Conceptually, the device memory might contain a signal memory partition 1631 (or several) that contains the raw signal data. There is a media memory partition 1632 that contains the raw (compressed) audio and video data. Also there is a processed data memory partition 1633 that contains the MHL instructions, rough-cut clips, and summary movies.

Using the device CPUs 1640, the necessary routines are run on smart phone device 1600. Signal processing routine 1641 performs the analyzer processing on the signal data and creates tagged data. The highlight creation routine 1642 performs interpreter processing on the tagged data and creates highlight data. The media extraction routine 1643 extracts clips from the media data. Summary movie creation routine 1644 uses the master highlight list and the media to create summary movies.

After processing the summary movie can be uploaded by the network, cell, and wired communication 1650 functions of smart phone device 1600 to a central cloud repository to facilitate sharing between other devices and other users. The signal data, media data, rough-cuts, and/or MHLs may also be uploaded to enable participant sharing of signals and media and machine learning to improve the processing.

In one embodiment, the signals and media data are captured during the activity. When the activity is over, the processing is triggered. In one embodiment, the signals and media are captured during the activity and at least signal processing routine 1641, highlight creation routine 1642, and media extraction routine 1643 integrate in near real-time. Summary movie creation routine 1644 is performed after the activity. See U.S. Provisional No. 62/098,173, entitled, “Constrained System Real-Time Editing of Long-Form Video,” filed on Dec. 30, 2014.

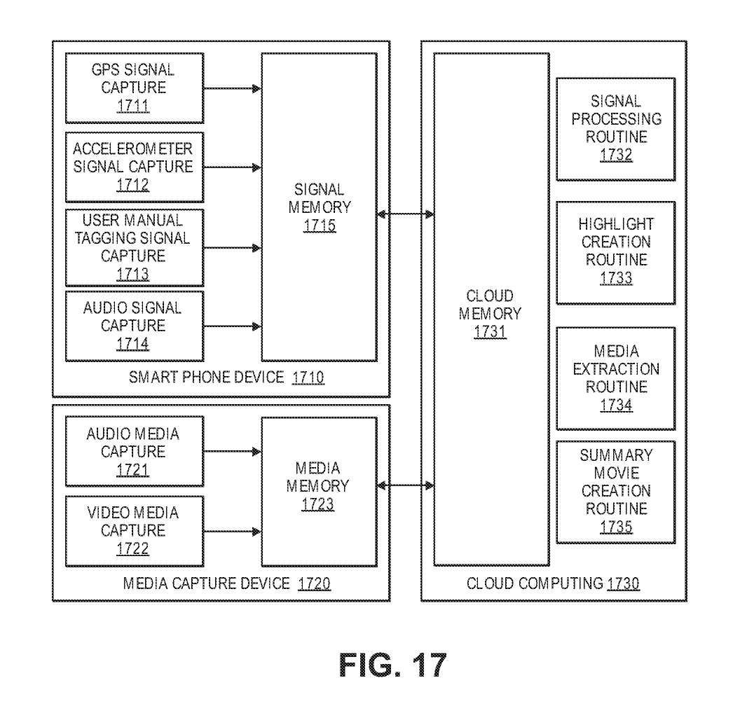

In one embodiment, the signals and/or media are captured by different device(s) than the processing. FIG. 17 shows one embodiment where the signals are captured by a smart phone device 1710 (e.g., an Apple iPhone), the media data is captured by a media capture device 1720 (e.g., a GoPro action camera), and the processing is performed by cloud computing 1730 (e.g., Amazon Web Services, Elastic Compute Cloud, etc.). If possible, the timing between smart phone device 1710 and media capture device 1720 is synchronized before recording the event. On smart phone device 1710, GPS signal capture 1711, accelerometer signal capture 1712, user manual tagging signal capture 1713, and audio signal capture 1714 are performed by dedicated hardware and the signals stored in signal memory 1715. At the end of the activity, the signals are uploaded to cloud memory 1731 of cloud computing 1730.

After the signals are uploaded to cloud memory 1731, signal processing routine 1732 and highlight creation routine 1733 can be executed.

Media capture device 1720 captures the movie data with audio media capture 1721 and video media capture 1722 and stores the media in the media memory 1723. At the end of the activity, the media are uploaded to cloud memory 1731 of cloud computing 1730.

After the signals and media are uploaded to cloud memory 1731 and signal processing routine 1732 and highlight creation routine 1733 are executed, media extraction routine 1734 and summary movie creation routine 1735 can be executed.

There are many embodiments possible for the arrangement of the processing. In one embodiment, a smart phone device captures the signals and the media; transfers the signals to the cloud; the cloud processes the signals and creates highlights; the cloud transfers the highlights back to the smart phone device; and the smart phone device uses the highlights and the media to extract clips and create a summary movie.

In another embodiment, a smart phone device captures the signals; a different media capture device captures the media; the smart phone devices transfers the signals to the cloud; the cloud processes the signals and creates highlights; the cloud transfers the highlights back to the smart phone device; the media capture device transfers the media to the smart phone; and the smart phone device uses the highlights and the media to extract clips and create a summary movie.

In one embodiment the highlight creation routine and media extraction routine are called twice. The first execution the highlight creation and media extraction routines are called to create rough-cut clips. The second execution the highlight creation and media extraction routines are called to create final-cut clips for the summary movie creation. The highlights used in the second execution are (most likely) a subset of the highlights and duration of the first execution.

There are a number of example embodiments disclosed herein. In a first example embodiment, a method comprises: playing back the media on a display of a media device; performing gesture recognition to recognize one or more gestures made with respect to the display; and navigating through media on a per highlight basis in response to recognizing the one or more gestures.

In another example embodiment, the subject matter of the first example embodiment can optionally include that navigating through the media comprises advancing or reversing the media in response to recognizing a first gesture.

In another example embodiment, the subject matter of the first example embodiment can optionally include that advancing or reversing the media comprises skipping back or skipping forward on one or more highlights at a time in response to a swiping gesture being recognized as occurring in a first direction across the screen or a second direction across the screen, respectively, the first and second directions being different.

In another example embodiment, the subject matter of the first example embodiment can optionally include that navigating through the media comprises scrubbing forward or reverse through the movie in response to recognizing a first gesture, including aligning a scrubbing position along a time line with a location in the media at which a highlight starts.

In another example embodiment, the subject matter of the first example embodiment can optionally include that navigating through the media comprises fast forwarding or fast reversing through the media in response to recognizing a first gesture.

In another example embodiment, the subject matter of the first example embodiment can optionally include that navigating through the media comprises skip forwarding or skip reversing through the media in response to recognizing a first gesture.

In another example embodiment, the subject matter of the first example embodiment can optionally include performing non-temporal editing of the media in response to at least one gesture of the one or more gestures.

In another example embodiment, the subject matter of the first example embodiment can optionally include that performing non-temporal editing of the media comprises: identifying a highlight for removal from the media using a first gesture of the one or more gestures; and editing the media by removing the highlight from the media in response to identifying the highlight.

In another example embodiment, the subject matter of the first example embodiment can optionally include that the first gesture comprises a swipe over the at least a portion of the highlight performed in a first direction.

In another example embodiment, the subject matter of the first example embodiment can optionally include that performing non-temporal editing of the media comprises: displaying thumbnail representations of highlights that are available for inclusion in the media but are not currently included in the media; identifying a highlight for inclusion in the media using a first gesture of the one or more gestures; and editing the media by adding the highlight to the media in response to identifying the highlight.

In another example embodiment, the subject matter of the first example embodiment can optionally include that display thumbnail representations of highlights comprises displaying the thumbnail representations in a mosaic configuration.

In another example embodiment, the subject matter of the first example embodiment can optionally include identifying a location in the media to insert the highlight as part of using the first gesture.

In another example embodiment, the subject matter of the first example embodiment can optionally include displaying a mosaic and a scrub timeline on the display simultaneously, wherein highlights in the media are visualized by images in mosaic and the scrub timeline.

In another example embodiment, the subject matter of the first example embodiment can optionally include: recognizing one or more drag-and-drop gestures performed on thumbnail representations of highlights in one or both of the mosaic and the scrub timeline; and editing the media based on the drag-and-drop gestures.

In another example embodiment, the subject matter of the first example embodiment can optionally include: recognizing at least one additional gesture performed on a representation of a highlight in the media; and editing a highlight to change highlight duration by trimming the highlight to reduce the duration of the highlight or by shifting a timing window of the highlight at its beginning or ending to expand the duration of the highlight and include media not included in the highlight prior to expansion.

In another example embodiment, the subject matter of the first example embodiment can optionally include: recording one or more editing operations made to edit the media; performing a function to reverse the one or more recorded editing operations.

In a second example embodiment, a system comprises: a touchscreen display playing back media, the touchscreen display having a plurality of sensor to detect user interaction made with respect to the touchscreen display and capture sensor data associated with detected user interactions; a gesture recognizer coupled to receive the sensor data and operable to perform gesture recognition to recognize one or more gestures made with respect to touchscreen display in proximity to the media being displayed using the sensor data; and a processor coupled to the recognizer to modify playback of the media and update display of the media to facilitate user navigation through the media on a per highlight basis in response to recognizing the one or more gestures.

In a third example embodiment, a method comprises: transferring media to a receiver for playback; enabling the receiver to access to rough cut and final cut clips and master highlight list information; performing, at the receiver, one or both of navigation and editing of the media on a per highlight basis using the master highlight list information.

In another example embodiment, the subject matter of the third example embodiment can optionally include that the master highlight list information is embedded as metadata in a media file format of the media.

In another example embodiment, the subject matter of the third example embodiment can optionally include: uploading versions of one or both of the rough cuts and final cuts to a remote repository; and transferring, to the receiver, portions of one or both of the rough cut and final cut versions as necessary for displaying during one or both of navigation and editing.

In another example embodiment, the subject matter of the third example embodiment can optionally include that the portions of one or both of the rough cuts and final cut versions are downloaded to the receiver.

In another example embodiment, the subject matter of the third example embodiment can optionally include that transferring the portions of one or both of the rough cuts and final cut versions comprises streaming one or more highlights as needed by the receiver for display.

In another example embodiment, the subject matter of the third example embodiment can optionally include that transferring the portions of one or both of the rough cuts and final cut versions comprises: transferring rough cut versions corresponding to highlights that are visible in the media, prior to playing back the movie; and then transferring rough cut version that have highlights not visible in the media.

In another example embodiment, the subject matter of the third example embodiment can optionally include that transferring rough cut version that have highlights not visible in the media is performed in the background.

In another example embodiment, the subject matter of the third example embodiment can optionally include that highlights in one or both of the rough cuts and final cut versions are concatenated together.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

We claim:

1. A method of processing a stream, the method comprising:
playing back the media on a display of a media device;
performing gesture recognition to recognize one or more gestures made with respect to the display; and
navigating through the media on a per highlight basis in response to recognizing the one or more gestures.

2. The method defined in claim 1 wherein navigating through the media comprises advancing or reversing the media in response to recognizing a first gesture.

3. The method defined in claim 2 wherein advancing or reversing the media comprises skipping back or skipping forward on one or more highlights at a time in response to a swiping gesture being recognized as occurring in a first direction across the screen or a second direction across the screen, respectively, the first and second directions being different.

4. The method defined in claim 1 wherein navigating through the media comprises scrubbing forward or reverse through the movie in response to recognizing a first gesture, including aligning a scrubbing position along a time line with a location in the media at which a highlight starts.

5. The method defined in claim 1 wherein navigating through the media comprises fast forwarding or fast reversing through the media in response to recognizing a first gesture.

6. The method defined in claim 1 wherein navigating through the media comprises skip forwarding or skip reversing through the media in response to recognizing a first gesture.

7. The method defined in claim 1 further comprising:
performing non-temporal editing of the media in response to at least one gesture of the one or more gestures.

8. The method defined in claim 7 wherein performing non-temporal editing of the media comprises:
identifying a highlight for removal from the media using a first gesture of the one or more gestures; and
editing the media by removing the highlight from the media in response to identifying the highlight.

9. The method defined in claim 8 wherein the first gesture comprises a swipe over the at least a portion of the highlight performed in a first direction.

10. The method defined in claim 7 wherein performing non-temporal editing of the media comprises:
displaying thumbnail representations of highlights that are available for inclusion in the media but are not currently included in the media;
identifying a highlight for inclusion in the media using a first gesture of the one or more gestures; and
editing the media by adding the highlight to the media in response to identifying the highlight.

11. The method defined in claim 10 wherein displaying thumbnail representations of highlights comprises displaying the thumbnail representations in a mosaic configuration.

12. The method defined in claim 10 further comprising identifying a location in the media to insert the highlight as part of using the first gesture.

13. The method defined in claim 1 further comprising displaying a mosaic and a scrub timeline on the display simultaneously, wherein highlights in the media are visualized by images in mosaic and the scrub timeline.

14. The method defined in claim 13 further comprising:
recognizing one or more drag-and-drop gestures performed on thumbnail representations of highlights in one or both of the mosaic and the scrub timeline; and
editing the media based on the drag-and-drop gestures.

15. The method defined in claim 1 further comprising:
recognizing at least one additional gesture performed on a representation of a highlight in the media; and
editing a highlight to change highlight duration by trimming the highlight to reduce the duration of the highlight or by shifting a timing window of the highlight at its beginning or ending to expand the duration of the highlight and include media not included in the highlight prior to expansion.

16. The method defined in claim 1 further comprising:
recording one or more editing operations made to edit the media;
performing a function to reverse the one or more recorded editing operations.

17. A system comprising:
a touchscreen display playing back media, the touchscreen display having a plurality of sensor to detect user interaction made with respect to the touchscreen display and capture sensor data associated with detected user interactions;
a gesture recognizer coupled to receive the sensor data and operable to perform gesture recognition to recognize one or more gestures made with respect to touchscreen display in proximity to the media being displayed using the sensor data; and
a processor coupled to the recognizer to modify playback of the media and update display of the media to facilitate user navigation through the media on a per highlight basis in response to recognizing the one or more gestures.

18. A method comprising:
transferring media to a receiver for playback;
enabling the receiver to access to rough cut and final cut clips and master highlight list information;
performing, at the receiver, one or both of navigation and editing of the media on a per highlight basis using the master highlight list information.

19. The method defined in claim 18 wherein the master highlight list information is embedded as metadata in a media file format of the media.

20. The method defined in claim 18 further comprising:
uploading versions of one or both of the rough cuts and final cuts to a remote repository; and
transferring, to the receiver, portions of one or both of the rough cut and final cut versions as necessary for displaying during one or both of navigation and editing.

21. The method defined in claim 20 wherein the portions of one or both of the rough cuts and final cut versions are downloaded to the receiver.

22. The method defined in claim 20 wherein transferring the portions of one or both of the rough cuts and final cut versions comprises streaming one or more highlights as needed by the receiver for display.

23. The method defined in claim 20 wherein transferring the portions of one or both of the rough cuts and final cut versions comprises:
transferring rough cut versions corresponding to highlights that are visible in the media, prior to playing back the movie; and
then transferring rough cut version that have highlights not visible in the media.

24. The method defined in claim 23 wherein transferring rough cut versions that have highlights not visible in the media is performed in the background.

25. The method defined in claim 18 wherein highlights in one or both of the rough cuts and final cut versions are concatenated together.
